(19) United States
(12) Patent Application Publication
(10) Pub. No.: US 2025/0391830 A1
(43) Pub. Date: Dec. 25, 2025

(54) High Cycle-Life Lithium-Ion Cells with Nano-Structured Silicon Comprising Anodes

(71) Applicant: LeydenJar Technologies B.V., Leiden (NL)

(72) Inventors: Ashley Cooke, Leiden (NL); Thijs Willem Dubbelink, Leiden (NL); Rohan Sivaraj, Leiden (NL); Yiseop Ahn, Leiden (NL); Zhaolong Li, Leiden (NL); Thomas Homewood, Leiden (NL)

(73) Assignee: LeydenJar Technologies B.V., Leiden (NL)

(21) Appl. No.: 18/879,571

(22) PCT Filed: Jul. 7, 2023
(86) PCT No.: PCT/NL2023/050370

§ 371 Date: Dec. 27, 2024

(30) Foreign Application Priority Data
Jul. 7, 2022 (NL) 2032414

(51) Int. Cl. H01M 4/04; H01M 4/38; H01M 4/587; H01M 10/0525; H01M 10/0568

(52) U.S. Cl. CPC H01M 4/0423; H01M 4/386; H01M 4/587; H01M 10/0525; H01M 10/0568; H01M 2300/0025

(57) ABSTRACT

The present application concerns a method of manufacturing a lithium-ion cell (12), comprising the steps of: (i) providing a silicon anode (6); (ii) pre-lithiating the silicon anode (6) to form a pre-lithiated silicon anode (1) with a pre-lithiation level of from 1% to 100%; (iii) providing a providing: a separator (2); an electrolyte; and a lithium-ion cathode (3); (iv) forming a lithium-ion cell from the pre-lithiated silicon anode (1), the separator (2) and the lithium-ion cathode (3), wherein the silicon anode (6) comprises a lithium storage material, in which the lithium storage material comprises between 70 and 100 wt. %, preferably 85 and 100 wt. % silicon, with respect to the lithium storage material, and wherein the lithium storage material comprises silicon material with a columnar morphology.

### FIELD OF THE INVENTION

The present invention relates to lithium-ion cells, in which the anode comprises pre-lithiated silicon, methods of their manufacture, batteries comprising such cells and uses of such cells and/or batteries.

### BACKGROUND OF THE INVENTION

A battery is a device consisting of one or more electrochemical cells with external connections that convert stored chemical energy into electrical energy. A cell has a positive electrode and a negative electrode, also termed respectively a cathode and an anode. When a battery is connected to an external circuit electrons flow from the anode to the cathode through the external circuit thereby delivering electrical energy to the circuit and any devices connected to the circuit.

Primary batteries such as alkaline batteries are one-time-use batteries as the electrode material changes permanently during discharge. Secondary batteries such as lithium-ion batteries can be charged and discharged multiple times as the original composition of the electrode material can be restored by applying a reverse current.

A cell is made up of two half-cells connected in series by a conductive electrolyte material. One of the half-cells contains the cathode, while the other half-cell contains the anode with the electrolyte present in both half-cells. A separator may be present between both half-cells. A separator prevents shorting between the cathode and anode, whilst still allowing ions to move across the separator between the two half-cells.

A particularly advantageous type of electrochemical cell is a lithium-ion cell. In lithium-ion cells, lithium-ions move from the negative electrode, or anode, through an electrolyte to the positive electrode, or cathode, during discharge and back during charging. Lithium-ion cells have historically employed an intercalated lithium compound at the positive electrode and graphite at the negative electrode. Lithium-ion cells generally possess higher energy dentistry than conventional lead-acid batteries, advantageously do not possess a memory effect and typically exhibit low self-discharge.

Recent developments in lithium-ion cells have sought to employ silicon in the anode material in place of the historically used graphite. This is because silicon allows much higher maximum capacities to be realised than the maximum capacity of approximately 370 mAh/g obtainable with graphite. For example, pristine silicon allows for a specific capacity of approximately 3600 mAh to be realised. Obtaining higher charge capacity without greatly increasing weight is a key challenge for improving the battery life of mobile phones, drones or electric cars.

A factor that has slowed the widespread commercialisation of lithium-ion cells with anodes that comprise silicon is that silicon typically exhibits a large volume change on lithium insertion, with an increase of up to 300 to 400% in volume possible. Such changes in volume typically cause large anisotropic stresses within the anode, which can lead to fracturing, crumbling or delamination of silicon material from the anode. Fracturing, crumbling or delamination of the silicon material from the anode reduce the charge capacity of the anode and reduce the charge cycle life of a cell comprising such an anode.

To overcome these swelling issues, a range of three dimensional silicon surface morphologies have been developed for use in anodes. One approach is develop so-called nanostructured architectures, with examples including three-dimensional thin-films, nanowires and nanotubes. Three-dimensional thin-film silicon anodes employ a geometry most similar to traditional thin-film batteries, in which a thin film of silicon deposited onto a metallic foil, in which the metallic foil serves as a current collector. Thin film “two dimensional” batteries are typically restricted to a film depth of between 2 and 5 micrometres to avoid cracking, crumbling and/or delamination of the silicon layer, limiting areal capacity to significantly less than that obtainable by three-dimensional thin-films.

Three-dimensional thin-films use the third dimension (corresponding to depth) to increase the electrochemically active area. One option to do this is to etch perforations into film of silicon by inductive coupled plasma etching on silicon. Another option is to deposit silicon by plasma enhanced chemical vapour deposition in such a way that a thin film of silicon is deposited on the metallic current collecting foil, in which the thin film is mostly formed of columns of silicon extending perpendicular to the metal foils surface. Such columns typically possess a diameter of a few hundred nanometres. Between the columns are a network of voids, or empty space. These nanostructured surface morphologies allow the columns to swell, that is to say increase in volume, and thereby extent into the voids. This means that little to no pressure is exerted by one column on an adjacent column on swelling, meaning that in aggregate, the bulk silicon material exerts little to no pressure parallel to the surface of the metal foil. This advantageously allows these materials with a nanostructured surface morphology to avoid cracking, crumbling or delamination.

Nanowires and nanotubes can also be used. One such example would be silicon nanowires grown on a steel current collector substrate by a vapour-liquid solid growth method. The wires are attached at one end to the current collector material, and an irregular network of silicon wires is believed to allow for accommodation of large strains on swelling due to incorporation of lithium. This advantageously allows these materials with a nanostructured surface morphology to avoid cracking, crumbling or delamination.

Overall these silicon containing anodes with three dimensional surface morphologies have comparatively high surface areas in of the anode in contact with the electrolyte. This is advantageous on one hand due increased areal capacity.

In a lithium-ion cell with a silicon-comprising anode, the SEI plays an especially important role in capacity degradation, due to the large volumetric changes during cycling. Expansion and contraction of the anode material typically cracks the SEI layer that has formed on top of it, exposing more of the anode material to direct contact with the electrolyte, which results in further SEI production and further LLI. This decreases the commercially useful charge cycle life-span of lithium-ion cells with a silicon-comprising anode. This problem of cracking of the SEI is particularly acute for anodes comprising silicon with a nanostructured surface morphology, due to the surface area and shapes of silicon material at the anode-electrolyte interphase.

Anodes comprising silicone and graphite components have been known for quite some time. Also a pre-lithiation process has been disclosed, when such anodes are included into batteries. For instance, US2021126250 discloses a silicon/graphite anode prepared by slurry deposition. EP3561918 also discloses a silicon/graphite electrode slurry coated electrode. WO2019113534A1 discloses anodes containing about 80 wt % Silicon particles, 5 wt % graphite and 15 wt % glass carbon from resin, which are laminated on a Cu foil. Each of these documents also discloses a manner of pre-lithiation, usually however with the use of a sacrificial lithium source.

A different strategy for the formation of the anode material involves structuring the silicon in the form of nanostructures such as nanoparticles, nanowires, nanotubes or more complex 3D structures. Through these nanostructures the silicon is provided with ample space to accommodate volume expansion, reducing internal stress and fractures, while also maintaining a high surface area for lithium-ion transport from electrolyte to silicon. For example, WO2010129910A2 discloses a conductive substrate and silicon containing nanowires substrate-rooted to the conductive substrate. WO2015175509A1 expands upon this concept by having two layers of silicon material coating a nanowire template rooted to the substrate, wherein the second silicon layer has a higher density than the first layer. WO2015175509A1 states that hereby the first silicon layer provides space into which the silicon can expand as it absorbs lithium, while the second silicon layer reduces SEI layer formation.

On the first charge cycle of lithium-ion cell operation, the electrolyte decomposes to form a range of typically ill-defined lithium containing compounds on the anode surface, producing a layer called the solid-electrolyte interphase (SEI). The solid-electrolyte interphase layer is a result of the reduction potential of the anode. During cycling, voltages are applied at which electrons reduce some of the components of the electrolyte. As the SEI layer is partially formed from lithium comprising compounds, production of SEI growth reduces the total charge capacity of the cell by consuming some of the lithium that could otherwise be used to store charge. This is a degradation mechanism known as Loss of Lithium Inventory (LLI). The properties and evolution of the solid-electrolyte interphase layer fundamentally affects the overall performance of the lithium-ion cell. Reasons for this include: (i) that the solid-electrolyte interphase layers permeability to lithium-ions can limit the rate and/or amount of lithium that the anode can store; and (ii) that the solid-electrolyte interphase layers electronic resistivity affects the rate at which the solid-electrolyte interphase layer grows. Typically, the more electronically conductive that the formed SEI layer is, the faster further electrolyte decomposition is and consequently the faster the SEI layer grows. SEI layer growth increases the Loss of Lithium Inventory (LLI). As LLI results in less lithium being available for cycling between the positive and negative electrode, this leads to a reduction in the capacity of lithium-ion cells.

As the loss of lithium-ions from the cathode and/or electrolyte reduce the overall capacity of the lithium-ion cell, attempts to reduce LLI or to compensate for LLI that occurs during charge cycling are an active area of research.

One approach is to “pre-lithiate” the anode material in situ. This involves designing a lithium-ion cell with additional, sacrificial lithium source and typically involves operating a first charge cycle on the cell under non-standard operating conditions. During operation of the cell, this results in consumption of the “sacrificial” source of lithium to afford the SEI and maintain a minimum level of energy storage. One approach is the use of a lithium metal foil as the in situ sacrificial lithium source, see US 2021/0104737 A1. This document discloses a silicon dominant anode comprising a composite material film comprising greater than 0% and less than about 90% by weight of silicon particles, and greater than 0% and less than about 90% by weight of one or more types of carbon phases, wherein at least one of the one or more types of carbon phases is a substantially continuous phase that holds the composite material film together such that the silicon particles are distributed throughout the composite.

Another approach is the use of “sacrificial electrolytes”. These are electrolytes that comprise lithium-ions at high molar concentrations than electrolytes optimal for ordinary cycling. During the first few cycles of lithium-ion cells comprising such electrolytes, lithium-ions and other electrolyte components are degraded to form the SEI. As higher lithium concentrations are used, the partial loss of lithium-ions from the electrolyte to form the SEI results in an electrolyte that may still function as a useful lithium-ion electrolyte.

An example for such a process is disclosed in US2021/0126250 A1, wherein lithium or a lithium compound is added to the interior of the silicon-based anode, such as lithium powder, lithium oxide, or lithium carbide powder in an early-stage slurry-stirring process or during late-stage rolling, either for a slurry-based material

However, even the use of sacrificial electrolytes typically results in partial loss of lithium from the cathode and an overall sub-optimal performance of the system as a whole. A further disadvantage is that to achieve the required high concentrations of lithium salts places significant restrictions on what solvent/salt combinations can be employed.

Generally, designing cells so that they comprise a sacrificial source that is consumed either (i) during an initial non-standard charge cycle or (ii) during ordinary use is disadvantageous as the cell must (i) comprise the additional sacrificial lithium source and (ii) typically operate under special initial SEI forming conditions for the first (few) cycle(s). This places undesirable limits on the weight and size of the cell, the operation conditions of the cell and/or which electrolyte systems can be utilised.

A further disadvantage of the in situ pre-lithiation/SEI formation approach is that anodes composed predominantly of silicon swell significantly during charging and discharging, which depending on the surface morphology leads to significant ablation of the SEI during the first (few) cycle(s). Ablated SEI materials that form during the initial pre-lithiation/SEI formation approach typically reduce overall charge capacity, cause variability on charge cycling and/or cause increased electrolyte decomposition, and may cause shorting of the lithium-ion cell. Control of surface morphology to reduce ablation of SEI has been partially successful, but it remains a challenge in providing charge-cycle life lithium-ion cells.

A goal of the disclosure of the present application is to provide a pre-lithiated silicon anode that is suitable for incorporation into cells and thereby obviates the requirement for an in situ sacrificial lithium ion source in the final lithium-ion cell.

### SUMMARY OF THE DISCLOSURE

In view of the above discussion, a first aspect of the present disclosure is a method of manufacturing a lithium-ion cell (12), comprising the steps of:
(i) providing a silicon anode (6);
(ii) pre-lithiating the silicon anode (6) to form a pre-lithiated silicon anode (1) with a pre-lithiation level of from 1% to 100%;
(iii) providing a providing: a separator (2); an electrolyte; and a lithium-ion cathode (3);
(iv) forming a lithium-ion cell from the pre-lithiated silicon anode (1), the separator (2) and the lithium-ion cathode (3), wherein the silicon anode (6) comprises a lithium storage material, in which the lithium storage material comprises between 70 and 100 wt. % silicon, preferably between 85 and 100 wt. % silicon, with respect to the lithium storage material, wherein the lithium storage material comprises silicon material with a columnar morphology; and a current collector.

The subject method is advantageous over known in-situ pre-lithiation methods in the state of the art, in that the pre-lithiation can be performed before assembly of the final cell. Accordingly, such a method advantageously can obviate the need the requirement for an in situ sacrificial lithium ion source in the final lithium-ion cell.

Another aspect of the present disclosure is a lithium-ion cell obtainable the previous aspect. Cells according to the disclosure typically provide unexpected and exceptional cycle-life and capacity properties, whist additionally conferring the advantage of obviates the need the requirement for an in situ sacrificial lithium ion source in the final lithium-ion cell.

Another aspect of the present disclosure is a lithium-ion cell (12) comprising:
a pre-lithiated silicon anode (3) with a pre-lithiation level of from 1% to 100%,
a separator (4);
an electrolyte (5); and
a lithium-ion cathode (6), preferably a lithium-ion cathode (6) with a lithiation level of from 70% to 100%, more preferably of from 80% to 99%, and again more preferably of from 90% to 98%.

Cells according to the disclosure provide unexpected and exceptional cycle-life and capacity properties, whist additionally conferring the advantage of obviates the need the requirement for an in situ sacrificial lithium ion source in the final lithium-ion cell.

In yet a further aspect, the present disclosure relates to a battery comprising at least one lithium-ion cell according to any previous embodiment of any previous aspect. An advantage of such a battery is that the mass of such a battery can be lower than those of the state of the art, whilst still possessing the same nominal voltage and capacity. In the context of the present disclosure a battery may contain one or more lithium-ion cells.

### SHORT DESCRIPTION OF THE FIGURES

FIG. 1 depicts schematically a method of manufacturing a lithium-ion cell according to the present disclosures.

FIG. 2A is a top-down scanning electron microscopy image obtained of an anode comprising a silicon layer in which the silicon layer comprises a plurality of columnar structures.

FIG. 2B is a cross-sectional scanning electron microscopy image obtained of an anode comprising a silicon layer in which the silicon layer comprises a plurality of columnar structures.

FIG. 3 is a graph of the first charge and discharge cycle properties observed for cells according to the invention (Example 3 dashed line) and comparative cells (Comparative Example 3A, solid line). Example 3, the cell according to the invention, exhibited a lower charge voltage and higher discharge voltage than Comparative Example 3A. Therefore, Example 3 exhibited a higher energy efficiency than Comparative Example 3A.

FIG. 4 is a graph of the capacity (Ah) against cycle number experimentally obtained for a material according to the present disclosure (Example 3) and a comparative example (Example 3A).

FIG. 5 is a graph of capacity retention (%) against cycle number experimentally obtained for a material according to the present disclosure (Example 3) and a comparative example (Example 3A).

FIG. 6 is a graph of specific capacity (Ah/g) against cycle number experimentally obtained for a material according to the present disclosure (Example 3) and a comparative example (Example 3A).

FIG. 7 is a graph of areal capacity (mAh/cm²) against cycle number experimentally obtained for a material according to the present disclosure (Example 3) and a comparative example (Example 3A).

FIG. 8 is a graph of accumulated specific capacity (Ah/g) against cycle number experimentally obtained for a material according to the present disclosure (Example 3) and a comparative example (Example 3A).

FIG. 9A is a graph of specific energy (mWh/cm²) against cycle number experimentally obtained for a material according to the present disclosure (Example 3) and a comparative example (Example 3A).

FIG. 9B is a graph of energy efficiency (%) against cycle number experimentally obtained for a material according to the present disclosure (Example 3) and a comparative example (Example 3A).

FIG. 10 is a graph of: (i) the number of charge cycles that can be performed until only 80% of the initial capacity of the full cell can be obtained; against (ii) the lithium reserve divided by the lithium utilization. The lithium reserve is the lithium content in the silicon in the discharged state of the full cell normalized to the mass of silicon in the silicon anode. Lithium utilization is the amount of lithium being used during cycling normalized to the mass of silicon in the silicon anode.

### DEFINITIONS AND ABBREVIATIONS

Additive: a component of an electrolyte that is present in an amount of from 0.01 to 10 wt. %.

Amorphous silicon: The term “amorphous silicon” herein is understood to mean as comprising protocrystalline silicon, which is a definition for amorphous silicon-comprising a fraction of nanocrystalline silicon. This fraction may be up to about 30% of the silicon layer. For ease of reference the term amorphous silicon will be used herein to indicate that the silicon layer comprises amorphous silicon, in which nano-crystalline regions of the silicon layer may be present with a fraction of nanocrystalline silicon up to about 30%.

Anode: an electrode through which electric charge flows into an electronic device. In the context of the electro-chemical perspective, anions (negatively charged ions) move toward the anode and/or cations (positively charged ions) move away from the anode to balance the electrons leaving the electrode to the electronic device. In a discharging lithium-ion battery or galvanic cell, the anode is the negative terminal from which electrons flow out. In a charging or recharging lithium-ion battery, the anode becomes the positive terminal into which electrons flow from the electronic device.

Capacity: the capacity of a battery or cell is the amount of electrical charge such a device can deliver. Capacity is expressed in units of mAh or Ah, and indicates the maximum constant current that a battery or cell can produce over an hour. For example, a battery with a capacity of 1 Ah can deliver 1 A for one hour or a current of 100 mA for 10 hours.

Cathode: an electrode through which electric charge flows out of an electronic device. In the context of the electro-chemical perspective, anions (negatively charged ions) move away from the anode and/or cations (positively charged ions) move towards the anode to balance the electrons entering the electrode from the electronic device. In a discharging lithium-ion battery or galvanic cell, the cathode is the positive terminal into which electrons flow. In a charging or recharging lithium-ion battery, the cathode becomes the negative terminal out of which electrons flow to the electronic device.

Cell: an electro-chemical device used for generating a voltage or current from a chemical reaction, or the reverse in which an applied current induces a chemical reaction.

Coulombic Efficiency (CE): the efficiency with which charge is transferred in a cell or battery. Coulombic efficiency may be defined as the amount of charge exiting the cell or battery during the discharge cycles divided by the amount of charge entering the cell or battery during the previous charging cycle.

DME: 1,2-dimethoxyethane

DEC: diethyl carbonate

Doping: The term “doping” is herein understood to mean introducing a trace of an element into a material to alter the original electrical properties of the material or to improve the crystal structure of the silicon material.

EC: ethylene carbonate

Electrolyte: a substance comprising free ions that behaves as an ionically conductive medium. In the context of the disclosures herein, electrolytes comprise ions in a solution.

FEC: Fluoroethylene carbonate.

Fluoroalkyl: an alkyl group wherein at least one C—H bond has been replaced with a C—F bond.

Fluoroalkyl ether: in the context of the disclosures herein, the term refer to a fluorinated ether having a general formula R¹—O—R², wherein at least one of R¹ and R² is independently selected from a fluoroalkyl. The fluoroalkyl chain may be straight chain, cyclic or branched. The fluoroalkyl ether may be partially or fully fluorinated. R¹ and R² my be the same of different from each other.

LiFSI: lithium bis(fluorosulfonyl)imide.

Perfluoroalkyl group: an alkyl group in which all C—H bonds have been replaced with C—F bonds.

Silicon anode: a silicon anode is an anode in which the majority of the mass is silicon, preferably at least 60 wt. %, more preferably at least 70 wt. % and most preferably at least 70 wt. %.

Specific areal capacity: this is the capacity per unit of area of the electrode or active material. The units of specific areal capacity are mAh/cm².

Specific capacity: this is the capacity per unit mass. In this patent, the mass specifically refers to the mass of silicon active material in the anode. Specific capacity may be expressed in units of mAh/g.

Solid Electrolyte Interphase (SEI): a passivation layer comprising decomposition materials arising from the electrochemical decomposition of the electrolyte at the electrode/electrolyte phase boundary of the anode. This is typically formed in during the first few cycles of a lithium-ion battery or cell.

TTE: 1,1,2,2-tetrafluoroethyl-2,2,3,3-tetrafluoropropyl ether.

### DETAILED DESCRIPTION OF THE INVENTION

### Method of Manufacturing a Lithium-Ion Cell

The present disclosure is directed to a method of manufacturing a lithium-ion cell (12), comprising the steps of:
(i) providing a silicon anode (6);
(ii) pre-lithiating the silicon anode (6) to form a pre-lithiated silicon anode (1) with a pre-lithiation level of from 1% to 100%;
(iii) providing a providing: a separator (2); an electrolyte; and a lithium-ion cathode (3);
(iv) forming a lithium-ion cell from the pre-lithiated silicon anode (1), the separator (2) and the lithium-ion cathode (3),
wherein the silicon anode (6) comprises:
   a lithium storage material, in which the lithium storage material comprises between 70 and 100 wt. % silicon, preferably in which the lithium storage material comprises between 85 and 100 wt. % silicon, with respect to the lithium storage material; wherein the lithium storage material comprises silicon material with a columnar morphology; and
   a current collector.

Such method is advantageous over known in-situ pre-lithiation methods in the state of the art, in that the pre-lithiation can be performed before assembly of the final cell. Furthermore, the specific selection of the silicon material with a columnar morphology allows for a stronger performance, and longer cycle live.

Accordingly, the method advantageously obviates the need the requirement for an in situ sacrificial lithium ion source in the final lithium-ion cell.

Preferably, the method comprises the additional step of:
washing the pre-lithiated silicon anode (1).

This additional step may advantageously remove any ablated SEI from the silicon anode surface that forms during the pre-lithiation step of connecting the silicon anode and sacrificial lithium-ion cathode of the first intermediate cell to an external circuit. Without being bound by theory, it is believed that the presence of ablated SEI material reduces the cycle life of a lithium-ion cell by degrading the electrolyte.

### Silicon Anode

The method according to the present disclosure comprises providing a silicon anode (6). The silicon anode according to the present disclosure comprises:
a lithium storage material, in which the lithium storage material comprises between 70 and 100 wt. % silicon, preferably in which the lithium storage material comprises between 85 and 100 wt. % silicon, preferably in which the lithium storage material comprises between 85 and 100 wt. % silicon, with respect to the lithium storage material; comprising a silicon material with a columnar morphology and
a current collector.

Preferably, the silicon anode according to the present disclosure comprises an interstitial adhesion layer.

### Current Collector

Preferably, the current collector material according to the disclosure each have a thickness of from 1 to 100 μm, preferably of from 5 or 10 to 50 μm, more preferably of from 10 to 15 μm or about 10 or 12 μm.

Advantageously, the current collector material according to the disclosure may comprise copper, tin, chromium, nickel, titanium, stainless steel, or silver, or alloys thereof, more preferably copper or nickel, or alloys thereof, most preferably copper.

The current collector material includes sheet-like materials produced by either cold rolling or electroplating, and can also comprise alloys of copper or titanium with elements such as magnesium, zinc, tin, phosphor and/or silver. It can be smooth, rough, or textured, with a tensile strength preferably ranging from 150 to 600 MPa, and might comprise a passivation layer deposited on the copper foil to protect the copper foil from oxidation in air. The sheet-like materials produced by cold rolling or electroplating can have certain defects such as rolling lines, potential strains, impurities, and native oxide, which can impact the quality of the active material layer. Thus, the current collector material may be subjected to surface treatment. For example, the roughness of the foil can be increased to varying degrees by attaching nodules of current collector material or other metals at the surface of the current collector material, by for example electroplating. Other surface treatment techniques known in the art include annealing, knurling, etching, liquefying, physical polishing and electro-polishing, and are used to improve the morphology of the current collector material prior to deposition of active material.

Preferably, the current collector material according to the disclosure comprises a metal, metal alloy and/or metal salts and/or oxide. The metal, metal alloy and/or metal salts and/or oxide according to the disclosure are advantageously selected from aluminium, copper, nickel, tin, tin, indium and zinc, preferably nickel, ZnO or SnO₂, most preferably ZnO; preferably, wherein the current collector comprises a copper or nickel core layer, more

Preferably a core layer doped with oxides or fluorides of zinc, aluminium, tin or indium. Preferably, the metal, metal alloy and/or metal salts and/or oxide or the core layer are in a layer at a thickness of from 0.1 to 5 nm, more preferably of from 1 to 2 nm. Preferably, a current collector according to the disclosure comprising copper or nickel comprises nickel, ZnO or SnO₂.

### Optional Interstitial Adhesion Layer

The pending international patent application WO2021029769 of current applicant discloses that an adhesion layer comprising a metal, metal alloy and/or metal salts and/or oxide attached to the current collector material, may advantageously increase the adhesion of the silicon material to the current collector material of the composite electrode. Such an interstitial adhesion layer is not essential. According to the present disclosure, the current collector material comprising a metal, metal alloy and/or metal salts and/or oxide adhesion layer preferably comprises an adhesion layer. This adhesion layer may however advantageously increase the adhesion between silicon material and the current collector material as different complexes of silicon are being formed on the interphase between the current collector material and the silicon. Such an adhesion layer preferably comprises nickel, zinc or tin, such as ZnO or SnO₂. The adhesion layer can be formed by coating or depositing the metal, metal alloy and/or metal salts and/or oxide on the current collector material. Preferably, the adhesion layer is in a layer at a thickness of from 0.1 to 5 nm, more preferably of from 1 to 2 nm.

### Lithium Storage Material

The lithium storage material in the context of the present disclosure comprises between 70 and 100 wt. % silicon. Preferably, the lithium storage material in the context of the present disclosure comprises between 85 and 100 wt. % silicon, with respect to the lithium storage material.

Preferably, the lithium storage material comprises of from 75.0 and 100.0 wt. % silicon, preferably comprises of from 80.0 and 100.0 wt. % silicon, more preferably comprises of from 85.0 and 100.0 wt. % silicon, yet more preferably between 90.0 and 100.0 wt. % silicon, more preferably of from 92.0 and 99.8 wt. % silicon, even more preferably of from 94.0 and 99.6 wt. % silicon, yet more preferably of form 96.0 and 99.4 wt. % silicon and still more preferably of from 98.0 and 99.2 wt. % silicon and most preferably of form 99.0 to 99.1 wt. % silicon.

Preferably, the material of the lithium storage material comprises amorphous silicon and nano-crystalline silicon alloy. In some embodiments, the lithium storage material may be present in the electrode layer as a nano-crystalline phase. Also, the lithium storage material may comprise a mixture of an amorphous material and nano-crystalline phase. For example, a mixture of amorphous silicon and nanocrystalline silicon, or a mixture of amorphous silicon with nano-crystalline silicon alloy, or a mixture of silicon and silicon-based alloy predominantly in an amorphous state comprising a fraction (up to about 30%) of the mixture in a nano-crystalline state.

The layer of lithium storage material according to the disclosure may advantageously comprise silicon oxide. The silicon layer according to the disclosure may be positioned on the current collector layer in a variety of configurations.

The lithium storage material comprises silicon material with a columnar morphology.

According to the present disclosure, the amorphous silicon columns are preferably extending in a perpendicular direction from the anode surface, i.e. the interphase between the anode layer and the electrolyte layer, in which the plurality of silicon columns are arranged adjacent to each other while separated by interphases extending perpendicularly to the anode surface.

Preferably, the silicon material of the lithium storage material comprises a plurality of columnar structures on the current collector. The lithium storage material is present on the current collector layer.

The lithium storage material according to the disclosure is preferably attached to the current collector layer, either directly, or by attachment to an interstitial adhesion layer, as a layer comprising a plurality of adjacent columns with a diameter of from 0.5 to 100 μm.

Preferably, the columns have a diameter of from 1 to 75 μm, more preferably of from 2 to 50 μm, even more preferably of from 3 to 25 μm, yet more preferably of from 4 to 20 μm, even more preferably of from 5 to 15 μm, yet more preferably of from 6 to 12 μm, most preferably of from 8 to 10 μm.

Preferably, the columns have a mean average diameter of from 1 to 75 μm, more preferably of from 2 to 50 μm, even more preferably of from 3 to 25 μm, yet more preferably of from 4 to 20 μm, even more preferably of from 5 to 15 μm, yet more preferably of from 6 to 12 μm, most preferably of from 8 to 10 μm.

Preferably, the columns predominantly extend in a perpendicular direction from the current collector layer surface, wherein the adjacent columns are separated by column boundaries extending in the perpendicular direction. This may be determined by cross-sectional electron microscopy.

Preferably, the method is one in which the lithium storage material comprises silicon material with nanoscale structures on the surface, and preferably a nanoscale with a columnar morphology or similar structures.

The silicon layer may be positioned on nanowire templates that are attached to a substrate such as the current collector layer or the adhesion layer. The term “nanowire” herein is understood to mean a branched or non-branched wire-like structure with at least one dimension with a length of up to about 1 μm. The nanowire is an electrically conductive material comprising for example carbon, a metal or a metal silicide such as nickel silicide, copper silicide, silver silicide, chromium silicide, cobalt silicide, aluminium silicide, zinc silicide, titanium silicide or iron silicide, preferably comprising at least one nickel silicide phase comprising Ni₂Si, NiSi or NiSi₂. The nanowire may be the same material as the current collector such as nickel, copper or titanium. Alternatively, the nanowire may be a separate material and layer from the current collector material such as a copper current collector coated with a nickel layer. One or more layers of active material such as silicon may be deposited on nanowires via for example PVD, CVD or PECVD. The silicon layer may comprise carbon, copper, a sulfide, a metal oxide, a fluorine containing compound, a polymer or a lithium phosphorous oxynitride. The silicon layer may be coated with a layer comprising carbon, copper, a sulfide, a metal oxide, a fluorine containing compound, a polymer or a lithium phosphorous oxynitride, preferably a carbon layer with a thickness of from 1 nm to 5 μm, preferably of from 10 nm to 1 μm.

Preferably, the method is one wherein the silicon anode (6) comprises a layer of lithium storage material.

Preferably, according to the disclosure the layer of lithium storage material has a thickness of from 0.1 to 1,000 μm, preferably of from 0.5 to 500 μm, more preferably of from 1 to 100 or 200 μm, even more preferably of from 1 to 30 or 50 μm, yet more preferably of from 3 μm to 20 μm, yet more preferably of from 5 to 15 μm and most preferably of from 6 to 10 μm. Alternatively, according to the disclosure, the layer of lithium storage material preferably has a mass loading of from 0.1 to 4.0 mg/cm², more preferably of from 0.5 or 0.8 to 2.0 to 2.5 mg/cm², or of from 2.5 to 3.5 or 4.0 mg/cm², most preferably of from 1.0 to 2.0 mg/cm². The mass loading pertains to mass loading of one layer of lithium storage material that is present on one side of a current collector layer.

Advantageously, the layer of lithium storage material according to the disclosure has a porosity of from 0% to 50%, more preferably 1%, 2%, 5% or 10% to 50%.

Preferably, the layer of lithium storage material according to the disclosure has a porosity of from 0% to 80%, preferably 5-60%, even more preferably, 10-40%, as determined by the BJH method of ISO 15901-2:2006

Preferably, the average pore size of the layer of lithium storage material is in the range of from 0.5 to 40 nm, preferably of from 1 to 20 nm.

Porosity and (average) pore size according to the disclosure are preferably determined according to the method specified by the ISO (International Organization for Standardization) standard: ISO 15901-2:2006 “Pore size distribution and porosity of solid materials by mercury porosimetry and gas adsorption—Part 2: Analysis of mesopores and macropores by gas adsorption” using nitrogen gas. Briefly, a N₂ adsorption-isotherm is measured at about −196° C. (liquid nitrogen temperature). According to the calculation method of Barrett-Joyner-Halenda (Barrett, E. P.; Joyner, L. G.; Halenda, P. P. (1951), “The Determination of Pore Volume and Area Distributions in Porous Substances. I. Computations from Nitrogen Isotherms”, Journal of the American Chemical Society, 73 (1): 373-380) the pore size and pore volume can be determined. Specific surface area can be determined from the same isotherm according to the calculation method of Brunauer-Emmett-Teller (Brunauer, S.; Emmett, P. H.; Teller, E. (1938), “Adsorption of Gases in Multimolecular Layers”, Journal of the American Chemical Society, 60 (2): 309-319). Both calculation methods are well-known in the art. A brief experimental test method to determine the isotherm can be described as follows: a test sample is dried at a high temperature and under an inert atmosphere. The sample is then dried and placed in the measuring apparatus. Next, the sample is brought under vacuum and cooled using liquid nitrogen. The sample is held at liquid nitrogen temperature during recording of the isotherm.

The layer of lithium storage material according to the disclosure has preferably an amorphous structure in which nano-crystalline regions exist. More preferably, the layer of lithium storage material and/or the columns of lithium storage material comprise up to 30% of nano-crystalline silicon. According to an embodiment, the layer of lithium storage material and/or the columns of the lithium storage material advantageously comprises n-type or p-type dopants to obtain a silicon layer of respectively n-type conductivity or p-type conductivity.

Advantageously, the lithium storage material columns may further comprise a silicon alloy, wherein the silicon alloy is preferably selected from the group comprising Si—C and/or Si—N. Preferably, the composite material according to the disclosure comprises carbon or an alloy comprising carbon or silicon. The silicon alloy may be either an addition or an alternative to the amorphous silicon. Thus, according to an aspect of the disclosure, the material of the columns comprises at least one material selected from amorphous silicon and amorphous silicon alloy.

### Separator

The method according to the present invention comprises providing a separator.

Separators suitable to use in the present disclosure are known to the skilled person and are commercially available.

A separator is present to prevent short circuits forming between the cathode and anode, while still allowing ions to flow between both electrodes.

The separator may be suitably selected: (i) glass fibre; (ii) a porous polymer film with or without a ceramic coating, such as a polyethylene- or polypropylene-based material, or (iii) a composite (e.g., a porous film of inorganic particles and a binder). One exemplary polymeric separator is a Celgard© K1640 polyethylene (PE) membrane. Another exemplary polymeric separator is a Celgard© 2500 polypropylene membrane. Another exemplary polymeric separator is a Celgard© 3501 surfactant-coated polypropylene membrane.

Another set of exemplary porous polymer film with a ceramic coating are the PE and PP separators obtainable from Gelon. One example of such a separator is the Gelon 16 μm thick PE Battery separator, which comprises a 12 μm thick polyethylene polymer film, coated on both sides with a 2 μm thick ceramic alumina layer to afford a separator with a porosity of 38%.

The separator may optionally be infused with an electrolyte.

### Electrolyte

Electrolytes suitable to use in the present disclosure are known to the skilled person and are commercially available. Suitable electrolytes comprise a lithium salt and a solvent.

### Lithium Salt

The first and second electrolytes are provided with a lithium salt concentration of 0.5 to 2 M (moles per dm³).

The lithium salt, or combination of lithium salts, participates in the cell's charge and discharge processes.

Preferably, the lithium salt comprises: LiAsF₆; Li₂SO₄; LiBF₄; LiBr; LiCF₃SO₃; LiCl; LiClO₄, LiI; LiNO₂; LiNO₃; LiSCN; lithium 2-trifluoromethyl-4,5-dicyanoimidazole (CAS: 761441-54-7); lithium (fluorosulfonyl)(trifluoromethylsulfonyl) imide (LiFTFSI); lithium bis(fluorosulfonyl)-imide (LiFSI); lithium bis(oxalato)borate (LiBOB); lithium bis(pentafluoroethanesulfonyl) imide (LiBETI); lithium bis(trifluoromethanesulfonyl)imide (LiTFSI); lithium difluoro (oxalato)borate (LiDFOB CAS: 409071-16-5); lithium trifluoromethanesulfonate (LiTf); LiPF₆; or any combination thereof.

More preferably, the electrolyte comprises 9 to 29 wt. %, with respect to the electrolyte, of a lithium salt selected from: LiAsF₆; Li₂SO₄; LiBF₄; LiBr; LiCF₃SO₃; LiCl; LiClO₄, LiI; LiNO₂; LiNO₃; LiSCN; lithium 2-trifluoromethyl-4,5-dicyanoimidazole (CAS: 761441-54-7); lithium (fluorosulfonyl) (trifluoromethylsulfonyl)imide (LiFTFSI); lithium bis(fluorosulfonyl)imide (LiFSI); lithium bis(oxalato)borate (LiBOB); lithium bis(pentafluoroethanesulfonyl) imide (LiBETI); lithium bis(trifluoromethanesulfonyl)imide (LiTFSI); lithium difluoro (oxalato)borate (LiDFOB CAS: 409071-16-5); lithium trifluoromethanesulfonate (LiTf); LiPF₆; or any combination thereof.

Most preferably, the lithium salt comprises essentially of lithium bis(fluorosulfonyl)imide.

### Solvent

The electrolyte comprises a solvent. The solvent is advantageously selected such that the lithium salt has a solubility of at least 0.3 M (mole/dm³) at 25° C. and 1 atm.

Preferably, the non-aqueous solvent is selected such that the lithium salt has a solubility in the selected solvent of at least 4 M at 25° C. and 1 atm, more preferably of at least 5 M at 25° C. and 1 atm.

Without being bound by theory, it is believed that the solvent molecules in the electrolyte according to the present disclosure are statistically most likely to be closely associated with the lithium-ion salt(s), forming aggregates. It is further believed that these solvent-lithium salt aggregates are suspended in a continuous phase of the diluent.

Preferably, the non-aqueous solvent is selected from a nonaqueous solvent comprising at least one of the following components (i) an ester, (ii) a sulfur-containing solvent, (iii) a phosphorus-containing solvent, (iv) an ether, (v) a nitrile, or (vi) any combination thereof.

### Ester Solvent

Preferably, the ester is be selected from: diethyl carbonate (DEC); difluoroethylene carbonate (DFEC); dimethyl carbonate (DMC); ethyl methyl carbonate (EMC); ethylene carbonate (EC); methyl 2,2,2,-trifluoroethyl carbonate (MFEC); propylene carbonate (PC); trifluoroethylene carbonate (TFEC); trifluoropropylene carbonate (TFPC); 2,2,2,-trifluorethyl trifluoroacetate; 2,2,2-trifluoroethyl acetate; alkyl carboxylic acid esters, such as ethyl acetate; ethyl propionate; ethyl trifluoroacetate; methyl butyrate, or any combination thereof.

More preferably, the ester is be selected from: 2,2,2,-trifluorethyl trifluoroacetate; 2,2,2-trifluoroethyl acetate; ethyl acetate; ethyl propionate; ethyl trifluoroacetate; methyl butyrate, and/or any combination thereof.

### Sulphur-Containing Solvent

Preferably, the sulphur-containing solvent is selected from sulfone solvents, sulfoxide solvents or any combination thereof. More preferably, the sulphur-containing solvent is selected from: dimethyl sulfone; dimethyl sulfone; ethyl methyl sulfone (EMS); ethyl vinyl sulfone (EVS); tetramethylene sulfone (TMS, sulfolane); dimethyl sulfoxide; ethyl methyl sulfoxide; ethyl methyl sulfone (EMS); ethyl vinyl sulfone (EVS); tetramethylene sulfone (TMS, sulfolane); dimethyl sulfoxide; ethyl methyl sulfoxide; or any combination thereof.

Phosphorus-Containing Solvents Preferably, the phosphorus-containing solvent is selected from organophosphorus compounds (such as organic phosphate, phosphites, phosphonates, phosphoramides), phosphazenes (organic or inorganic) or any combination thereof. These phosphorus-containing solvents are generally flame retardant.

More preferably, the phosphorus-containing solvent is selected from: bis(2,2,2-trifluoroethyl) methyl phosphate; tributyl phosphate; triethylphosphate (TEPa); trimethyl phosphate (TMPa); triphenyl phosphate; tris (2,2,2-trifluoroethyl) phosphate; trimethyl phosphite; triphenyl phosphite; tris(2,2,2-trifluoroethyl) phosphite; dimethyl methylphosphonate; diethyl ethylphosphonate; diethyl phenylphosphonate; bis(2,2,2-trifluorethyl)methylphosphonate; hexamethylphosphoramide; hexamethoxyphosphazene (CAS: 957-13-1); hexamethoxycyclotriphosphazene (CAS: 6607-30-3); hexafluorophosphazene (CAS: 15599-91-4); or any combination thereof.

### Ether Solvent

Preferably, the ether solvent is selected from: 1,2-dimethoxyethane (DME); diethylene glycol dimethyl ether (diglyme, DEGDME); triethylene glycol dimethyl ether (triglyme); tetraethylene glycol dimethyl ether (tetraglyme); 1,3-dioxolane (DOL); allyl ether; or any combination thereof.

### Nitrile Solvents

Preferably, the nitrile solvent is selected from: acetonitrile; propionitrile; succinonitrile; adiponitrile (CAS: 111-69-3); or any combination thereof.

The electrolyte preferably comprises a non-aqueous solvent selected from: dimethyl carbonate (DMC); ethyl methyl carbonate (EMC); diethyl carbonate (DEC); ethylene carbonate (EC); propylene carbonate (PC); difluoroethylene carbonate (DFEC); trifluoroethylene carbonate (TFEC); trifluoropropylene carbonate (TFPC); methyl 2,2,2-trifluoroethyl carbonate (MFEC); ethyl acetate; ethyl propionate; methyl butyrate; ethyl trifluoroacetate; 2,2,2-trifluoroethyl acetate; 2,2,2-trifluoroethyl trifluoroacetate; dimethyl sulfone (DMS); ethyl methyl sulfone (EMS); ethyl vinyl sulfone (EVS); tetramethylene sulfone (TMS); dimethyl sulfoxide; ethyl methyl sulfoxide; trimethyl phosphate (TMPa); triethyl phosphate (TEPa); tributyl phosphate; triphenyl phosphate; tris(2,2,2-trifluoroethyl) phosphate; bis(2,2,2-trifluoroethyl) methyl phosphate; trimethyl phosphite; triphenyl phosphite; tris(2,2,2-trifluoroethyl) phosphite; dimethyl methylphosphonate; diethyl ethylphosphonate; diethyl phenylphosphonate; bis(2,2,2-trifluoroethyl)methylphosphonate; hexamethylphosphoramide; hexamethoxyphosphazene; hexamethoxycyclotriphosphazene; hexafluorophosphazene; 1,2-dimethoxyethane (DME); diethylene glycol dimethyl ether (diglyme, DEGDME); triethylene glycol dimethyl ether (triglyme); tetraethylene glycol dimethyl ether (tetraglyme); 1,3-dioxolane (DOL); allyl ether; acetonitrile; propionitrile; succinonitrile; adiponitrile (CAS: 111-69-3); or any combination thereof.

Even more preferably, the non-aqueous solvent is selected from: ethyl acetate; ethyl propionate; methyl butyrate; ethyl trifluoroacetate; 2,2,2-trifluoroethyl acetate; 2,2,2-trifluoroethyl trifluoroacetate; dimethyl sulfone (DMS); ethyl methyl sulfone (EMS); ethyl vinyl sulfone (EVS); tetramethylene sulfone (TMS); dimethyl sulfoxide; ethyl methyl sulfoxide; trimethyl phosphate (TMPa); triethyl phosphate (TEPa); tributyl phosphate; triphenyl phosphate; tris(2,2,2-trifluoroethyl) phosphate; bis(2,2,2-trifluoroethyl) methyl phosphate; trimethyl phosphite, triphenyl phosphite; tris(2,2,2-trifluoroethyl) phosphite; dimethyl methylphosphonate; diethyl ethylphosphonate; diethyl phenylphosphonate; bis(2,2,2-trifluoroethyl)methylphosphonate; hexamethylphosphoramide; hexamethoxyphosphazene (cyclo-tris(dimethoxyphosphonitrile); hexamethoxycyclotriphosphazene); hexafluorophosphazene (hexafluorocyclotriphosphazene); 1,2-dimethoxyethane (DME); diethylene glycol dimethyl ether (DEGDME, or diglyme); triethylene glycol dimethyl ether (triglyme); tetraethylene glycol dimethyl ether (tetraglyme); 1,3-dioxolane (DOL); allyl ether; acetonitrile; propionitrile; or any combination thereof.

Preferably, the solvent is a mixture of FEC and DEC. Most preferably, the solvent is a 3:7 (volume to volume) mixture of FEC: DEC.

### Preferable Electrolyte Composition Ratios

Preferably, the electrolyte according the present disclosure has a lithium salt concentration of from 0.01 to 10 M (mole/dm³), more preferably of from 0.1 to 5 M, even more preferably of from 0.2 to 3 M, yet more preferably still of from 0.5 to 2 M and most preferably of 1 M at 1 atmosphere and 25° C.

### Preferable Additives

Preferably, the electrolyte according to the disclosure additionally comprises an additive. The additive has a different composition than: (i) the lithium salt; (ii) the solvent; and (iii) the diluent. Optionally, the additive is a flame retardant.

Preferably, the additive comprises: 4-Fluoro-1,3-dioxolan-2-one (FEC, CAS: 114435-02-8), 1,3-Dioxol-2-one (VC, vinylene carbonate, CAS: 872-36-6), 1,4-Dicyanobutane, (adiponitrile, CAS: 111-69-3), Lithium difluorophosphate (LiDFP), 4,5-dimethylene-1,3-dioxolan-2-one; 1,3,2-dioxathiolane-2-oxide (CAS: 3741-38-6); 1,3,2-dioxathiolane-2,2-dioxide (CAS: 1072-53-3); 1,3,2-dioxathiane-2,2-dioxide (DTD, CAS: 1072-53-3); 3-methyl-1,4,2-dixoazol-5-one (CAS: 854849-14-2); Tris(2,2,2-trifluoroehtyl)phosphite (TTFEPi, CAS: 370-69-4); 1,3,2-Dioxathiane 2-oxide (CAS: 4176-55-0); 1-methylsulfonylethene (CAS: 3680-02-2); 1-ethenylsulfonylethene (CAS: 77-77-0); or any combination thereof.

### Divider

In any aspect of the present disclosure, a divider is a material that ensures no physical, electrical or ionic connection between layers it divides.

Dividers suitable to use in the present disclosure are known to the skilled person and are commercially available. An example of a suitable divider is a polypropylene sheet.

### (Non-Sacrificial) Lithium-Ion Cathode

The method according to the present invention comprises providing a (non-sacrificial) lithium-ion cathode (3).

Cathodes suitable to use in the present disclosure are known to the skilled person and are commercially available.

Preferably cathodes, or positive electrodes, or the materials they are essentially composed of are selected from:
a carbon/sulphur composite, or an air electrode, in particular carbon-based electrodes comprising graphitic carbon and, optionally, a metal catalyst such as Ir, Ru, Pt, Ag, or Ag/Pd); carbon monofluoride; CuO (copper (II) oxide); Cr₂O₅; Cr₃O₈; Iron disulfide; Li₂M²SiO₄ (M²=Mn, Fe, or Co), Li₂M²SO₄ (M²=Mn, Fe, or Co), LiM₂SO_{4 m}F (M²=Fe, Mn, or Co), Li₂₋ₓ (Fe_{1-y}Mn_{y})P₂O₇ (0≤x≤1; 0≤y≤1), Li₃V₂₋ₓ M1ₓ (PO₄)₃ (M1=Cr, Co, Fe, Mg, Y, Ti, Nb, or Ce; 0≤x≤1); Li₄₋ₓMₓ Ti₅O₁₂ (M=Mg, Al, Ba, Sr, or Ta; 0≤x≤1); LiCoO₂; LiFePO₄ (LFP); LiMC1ₓ MC²₁₋ₓO₂ ((MC1 and MC2 independently are Fe, Mn, Ni, Co, Cr, Ti, Mg, or Al; 0≤x≤1); LiMC1ₓMC2₁₋ₓPO₄ (MC1 or MC2=Fe, Mn, Ni, Co, Cr, or Ti; 0≤x≤1); LiMC1ₓMC2_{y}MC3_{1-x-y}O₂ (MC1, MC2, and MC3 independently are Fe, Mn, Ni, Co, Cr, Ti, Mg, or Al; 0≤x≤1; 0≤y≤1, 0≤x+y≤1); LiMn₂O₄ (LMO); LiMn_{2-y}X_{y}O₄ (X=Cr, Al, or Fe, 0≤y≤1); LiNi_{0.5}Mn_{1.5}O₄ spinel; LiNi_{0.5-y}X_{y}Mn_{1.5}O₄ (X=Fe, Cr, Zn, Al, Mg, Ga, V, or Cu; 0≤y<0.5); LiNi_{0.8}Co_{0.15}Al_{0.05}O₂ (NCA); LiNiₓMn_{y}Co_{Z}O₂ (NMC, x+y+z=1), Li-rich Li_{1+w}NiₓMn_{y}Co_{Z}O₂ (x+y+z+w=1, 0≤w≤0.25); LiV₃O₈; LiVPO₄F; MnO₂; Thionyl chloride; V₂O₅; V₆O₁: XLi₂MnO₃·(1−x)LiM¹_{y}M² M³_{1-y-z}O₂, wherein M¹, M², and M³ independently are Mn, Ni, Co, Cr, Fe, or mixture thereof; and wherein x=0.3-0.5; y≤0.5; z≤0.5.

In a preferred embodiment, the cathode is a lithium conversion compound, such as Li₂O₂, Li₂O, Li₂S, or LiF. More preferably, the cathode comprises LiNi_{X}Mn_{Y}Co_{Z}O₂ where x≥0.6 (NMC) or LiNiₓMg_{y}Ti_{1-x-y}O₂ where 0.9≤x<1 (NMT; e.g., LiNi_{0.96}Mg_{0.02} Ti_{0.02}O₂).

In a particularly preferred embodiment, the cathode is selected from one or more high voltage cathodes, by which is meant a cathode that can operate at from 4.3 to 4.6 V.

### Solid Electrolyte Interphase Layer

This may be any solid electrolyte interphase layer formed by charging and discharging the silicon anode (6) in the presence of a lithium salt containing electrolyte and the sacrificial cathode (4).

### Step of Pre-Lithiating the Silicon Anode to Form a Pre-Lithiated Silicon Anode

The method of the present disclosure involves a step of pre-lithiating the silicon anode (6) to form a pre-lithiated silicon anode (1) with a pre-lithiation level of from 20% to 100%.

The pre-lithiation level is defined as [(amount of lithium comprised in the silicon anode)/(theoretical maximum amount of lithium that can be comprised in the silicon anode)]×100.

Preferably, the silicon anode (6) is pre-lithiated to form a pre-lithiated silicon anode (1) with a pre-lithiation level of from 2% to 80%, preferably of from 3% to 60%, even more preferably of from 5% to 40%, yet more preferably of from 10% to 30% and most preferably of from 15% to 20%.

Preferably, the step of pre-lithiating the silicon anode (6) to form a pre-lithiated silicon anode (1) with a pre-lithiation level of from 20% to 100% is selected from one of the following methods:
electrochemical pre-lithiation of the silicon anode (6) with a sacrificial lithium-ion cathode (4);
treating the silicon anode (6) with a sacrificial electrolyte salt; or
physical deposition of lithium on the silicon anode (6).
   Electrochemical Pre-Lithiation of the Silicon Anode (6) with a Sacrificial Lithium-Ion Cathode (4)

The method according to the present invention optionally comprises pre-lithiating the silicon anode (6) to form a pre-lithiated silicon anode (1) with a pre-lithiation level of from 20% to 100% by electrochemical pre-lithiation of the silicon anode (6) with a sacrificial lithium-ion cathode (4).

### Sacrificial Lithium-Ion Cathode

Cathodes suitable to use in the present disclosure as sacrificial cathodes are known to the skilled person and are commercially available.

Preferably cathodes, or positive electrodes, or the materials they are essentially composed of are selected from:
a carbon/sulphur composite, or an air electrode, in particular carbon-based electrodes comprising graphitic carbon and, optionally, a metal catalyst such as Ir, Ru, Pt, Ag, or Ag/Pd); carbon monofluoride; CuO (copper (II) oxide); Cr₂O₅; Cr₃O₈; Iron disulfide; Li₂M²SiO₄ (M²=Mn, Fe, or Co), Li₂M²SO₄ (M²=Mn, Fe, or Co), LiM₂SO_{4 m}F (M²=Fe, Mn, or Co), Li₂₋ₓ (Fe_{1-y}Mn_{y})P₂O₇ (0≤x≤1; 0≤y≤1), Li₃V₂₋ₓ M1ₓ (PO₄)₃ (M1=Cr, Co, Fe, Mg, Y, Ti, Nb, or Ce; 0≤x≤1); Li₄₋ₓMₓ Ti₅O₁₂ (M=Mg, Al, Ba, Sr, or Ta; 0≤x≤1); LiCoO₂; LiFePO₄ (LFP); LiMC1ₓ MC²₁₋ₓO₂ ((MC1 and MC2 independently are Fe, Mn, Ni, Co, Cr, Ti, Mg, or Al; 0≤x≤1); LiMC1ₓMC2₁₋ₓPO₄ (MC1 or MC2=Fe, Mn, Ni, Co, Cr, or Ti; 0≤x≤1); LiMC1ₓMC2_{y}MC3_{1-x-y}O₂ (MC1, MC2, and MC3 independently are Fe, Mn, Ni, Co, Cr, Ti, Mg, or Al; 0≤x≤1; 0≤y≤1, 0≤x+y≤1); LiMn₂O₄ (LMO); LiMn_{2-y}X_{y}O₄ (X=Cr, Al, or Fe, 0≤y≤1); LiNi_{0.5}Mn_{1.5}O₄ spinel; LiNi_{0.5-y}X_{y}Mn_{1.5}O₄ (X=Fe, Cr, Zn, Al, Mg, Ga, V, or Cu; 0≤y<0.5); LiNi_{0.8}Co_{0.15}Al_{0.05}O₂ (NCA); LiNiₓMn_{y}Co_{Z}O₂ (NMC, x+y+z=1), Li-rich Li_{1+w}NiₓMn_{y}Co_{Z}O₂ (x+y+z+w=1, 0≤w≤0.25); LiV₃O₈; LiVPO₄F; MnO₂; Thionyl chloride; V₂O₅; V₆O₁: XLi₂MnO₃·(1−x)LiM¹_{y}M² M³_{1-y-z}O₂, wherein M¹, M², and M³ independently are Mn, Ni, Co, Cr, Fe, or mixture thereof; and wherein x=0.3-0.5; y≤0.5; z≤0.5.

In a preferred embodiment, the cathode is a lithium conversion compound, such as Li₂O₂, Li₂O, Li₂S, or LiF. More preferably, the cathode comprises LiNi_{X}Mn_{Y}Co_{Z}O₂ where x≥0.6 (NMC) or LiNiₓMg_{y}Ti_{1-x-y}O₂ where 0.9≤x<1 (NMT; e.g., LiNi_{0.96}Mg_{0.02} Ti_{0.02}O₂).

In a particularly preferred embodiment, the cathode is selected from one or more high voltage cathodes, by which is meant a cathode that can operate at from 4.3 to 4.6 V.

Treating the Silicon Anode (6) with a Sacrificial Electrolyte Salt; or

This may optionally be achieved by contacting the silicon anode (6) with a reactive lithium ion salt, preferably an organometallic lithium salt.

More preferably, the silicon anode (6) is contacted with an organometallic lithium salt under a dry and inert atmosphere, such as oxygen free argon or nitrogen. Even more preferably, the organometallic salt is selected from methyl lithium, n-butyl lithium, sec-butyl lithium, isopropyl lithium, tert-butyl lithium, phenyl lithium or any combination thereof. Most preferably, the organometallic salt is n-butyl lithium.

Preferably, the organometallic lithium salt is provided as a solution in an alkane solvent, an ether solvent or a combination thereof, more preferably in an alkane solvent.

### Physical Deposition of Lithium on the Silicon Anode

This may optionally be achieved by lithium sputtering onto the silicon anode (6) or by contacting the silicon anode (6) with lithium foil.

### Product-by-Process

Another aspect of the disclosure relates to a lithium-ion cell obtainable by a method as set out herein above. A lithium-ion cell according to this aspect of the disclosure surprisingly possessed a superior cycle-life and capacity.

### Lithium-Ion Cell

Another aspect of the disclosure relates to a lithium-ion cell (12) comprising:
a pre-lithiated silicon anode (3) with a pre-lithiation level of from 1% to 100%,
a separator (4);
an electrolyte (5); and
a lithium-ion cathode (6).

Preferably, the lithium-ion cathode (6) has a lithiation level of from 70% to 100%, more preferably of from 80% to 99%, and again more preferably of from 90% to 98%, such as for instance a lithium-ion cathode (6) with a lithiation level of from 90% to 100%. More preferably, the lithium-ion cathode (6) has a lithiation level of from 91% to 99%, more preferably of from 92% to 98%, even more preferably of from 93% to 97%, yet more preferably of from 94% to 96% and most preferably of 95%.

In an embodiment, a lithium-ion cell according to the invention possesses an advantageous performance, in particular a high capacity, high capacity retention, high specific capacity and long cycle-life.

Without being bound by theory, it is believed that such cells possess a higher store of electrochemically available lithium ions in (i) the anode and (ii) anode than comparable cells.

The pre-lithiated silicon anode (3) with a pre-lithiation level of from 1% to 100% may be as prepared as described in any previous aspect of the present disclosure.

Preferably, the pre-lithiated silicon anode (3) has a pre-lithiation level of from 2% to 80%, preferably of from 3% to 60%, even more preferably of from 5% to 40%, yet more preferably of from 10% to 30% and most preferably of from 15% to 20%.

The separator (4) is as described in the previous aspects. The electrolyte (5) is as described in the previous aspects.

### Lithium-Ion Cathode

The lithium-ion cell according to this aspect of the invention comprises a lithium-ion cathode (6).

Preferably, the lithium-ion cathode (6) has a lithiation level of from 70% to 100%, more preferably of from 80% to 99%, and again more preferably of from 90% to 98%, such as for instance a lithium-ion cathode (6) with a lithiation level of from 90% to 100%.

The lithiation level is defined as [(amount of lithium actually present in cathode)/(theoretical maximum amount of lithium that the cathode can comprise)]×100.

The lithium-ion cathode (6), having a lithiation level of from 70% to 100%, more preferably of from 80% to 99%, and again more preferably of from 90% to 98%, such as for instance a lithium-ion cathode (6) with a lithiation level of from 90% to 100% may be as prepared as described in any previous aspect of the present disclosure. Preferably, the lithium-ion cathode (6) has a lithiation level of from 91% to 99%, more preferably of from 92% to 98%, even more preferably of from 93% to 97%, yet more preferably of from 94% to 96% and most preferably of 95%.

Preferably, the lithium-ion cathode (6) is selected from a carbon/sulphur composite, or an air electrode, in particular carbon-based electrodes comprising graphitic carbon and, optionally, a metal catalyst such as Ir, Ru, Pt, Ag, or Ag/Pd); carbon monofluoride; CuO (copper (II) oxide); Cr₂O₅; Cr₃O₈; Iron disulfide; Li₂M²SiO₄ (M²=Mn, Fe, or Co), Li₂M²SO₄ (M²=Mn, Fe, or Co), LiM₂SO_{4 m}F (M²=Fe, Mn, or Co), Li₂₋ₓ (Fe_{1-y}Mn_{y})P₂O₇ (0≤x≤1; 0≤y≤1), Li₃V₂₋ₓ M1ₓ (PO₄)₃ (M1=Cr, Co, Fe, Mg, Y, Ti, Nb, or Ce; 0≤x≤1); Li₄₋ₓMₓ Ti₅O₁₂ (M=Mg, Al, Ba, Sr, or Ta; 0≤x≤1); LiCoO₂; LiFePO₄ (LFP); LiMC1ₓ MC²₁₋ₓO₂ ((MC1 and MC2 independently are Fe, Mn, Ni, Co, Cr, Ti, Mg, or Al; 0≤x≤1); LiMC1ₓMC2₁₋ₓPO₄ (MC1 or MC2=Fe, Mn, Ni, Co, Cr, or Ti; 0≤x≤1); LiMC1ₓMC2_{y}MC3_{1-x-y}O₂ (MC1, MC2, and MC3 independently are Fe, Mn, Ni, Co, Cr, Ti, Mg, or Al; 0≤x≤1; 0≤y≤1, 0≤x+y≤1); LiMn₂O₄ (LMO); LiMn_{2-y}X_{y}O₄ (X=Cr, Al, or Fe, 0≤y≤1); LiNi_{0.5}Mn_{1.5}O₄ spinel; LiNi_{0.5-y}X_{y}Mn_{1.5}O₄ (X=Fe, Cr, Zn, Al, Mg, Ga, V, or Cu; 0≤y<0.5); LiNi_{0.8}Co_{0.15}Al_{0.05}O₂ (NCA); LiNiₓMn_{y}Co_{Z}O₂ (NMC, x+y+Z=1), Li-rich Li_{1+w}NiₓMn_{y}Co_{Z}O₂ (x+y+Z+w=1, 0≤w≤0.25); LiV₃O₈; LIVPO₄F; MnO₂; Thionyl chloride; V₂O₅; V₆O₁: xLi₂MnO₃·(1−x) LiM¹_{y}M² M³_{1-y-z}O₂, wherein M¹, M², and M³ independently are Mn, Ni, Co, Cr, Fe, or mixture thereof; and wherein x=0.3-0.5; y≤0.5; z≤0.5; or LICl.

Preferably, the lithium-ion cathode (6) has a lithiation level of from 91% to 99%, more preferably of from 92% to 98%, even more preferably of from 93% to 97%, yet more preferably of from 94% to 96% and most preferably of 95%.

### Batteries

In yet a further aspect, the present disclosure relates to a battery comprising at least one lithium-ion cell according to any previous embodiment of any previous aspect. An advantage of such a battery is that the mass of such a battery can be lower than those of the state of the art, whilst still possessing the same nominal voltage and capacity. In the context of the present disclosure a battery may contain one or more lithium-ion cells.

### Battery Shapes

Examples of such batteries are cylindrical, prismatic, pouch and coin batteries. Several configurations of lithium-ion cells can also be combined. For example, a coin cell can have an internal cylindrical configuration (as disclosed in international patent application WO2015188959A1) or a pouch cell can have an internal prismatic configuration.

Generally, lithium-ion secondary batteries are manufactured as follows. Firstly, positive and negative electrodes are provided. Subsequently, a plurality of positive electrode plates and a plurality of negative electrode plates are stacked in the state in which the separators are interposed respectively between the positive electrode plates and the negative electrode plates in order to manufacture a battery cell having a predetermined shape. Subsequently, the battery cell is placed in a battery case, and the electrolyte is provided to the battery case. The battery case is then usually sealed, resulting in a battery, such as a battery pack.

Electrode leads are connected to a general electrode assembly. Each of the electrode leads is configured to have a structure in which one end of the electrode lead is connected to the electrode assembly, the other end of the electrode lead is exposed outward from the battery case, and the battery case, in which the electrode assembly is placed, is sealed by an adhesive layer, such as a sealant layer, at the portion of the battery case from which the electrode lead extends outward from the battery case.

In addition, the electrode assembly is provided with electrode tabs. Each current collector plate of the electrode assembly includes a coated part, on which an electrode active material is coated, and an end part (hereinafter, referred to as a “non-coated part”), on which the electrode active material may be uncoated. Each of the electrode tabs may be formed by connecting the uncoated part, or preferably by connecting a separate conductive tab connected to the electrodes, even more preferably by ultrasonic welding. These electrode tabs may protrude in one direction such that the electrode tabs are formed at the electrode assembly so as to be arranged side by side. Alternatively, the electrode tabs may protrude in opposite directions. Each electrode tab conveniently then serves as a path along which electrons move between the inside and the outside of the battery. Also, each of the electrode leads is preferably connected to a corresponding electrode tab by spot welding.

The electrode leads may extend in the same direction or in opposite direction depending on the position at which positive electrode tabs and negative electrode tabs are formed. A positive electrode lead and a negative electrode lead may be made of different materials. Finally, the electrode leads are electrically connected to external terminals via terminal parts thereof.

A pouch-shaped sheathing member contains the electrode assembly in a sealed state such that a portion of each of the electrode leads, e.g., the terminal part of each of the electrode leads, is exposed from the pouch-shaped sheathing member. As previously described, the adhesive layer, such as a sealant layer, is interposed between each of the electrode leads and the pouch-shaped sheathing member. The pouch-shaped sheathing member is provided at the edge thereof with a sealed region. A horizontal slit of each of the electrode leads is spaced apart from the sealed region toward a joint. That is, in the case in which each of the electrode leads is formed so as to have an inverted T shape, the leg part of the T shape protrudes outward from the pouch-shaped sheathing member whereas a portion of the head part of the T shape is located in the sealed region.

### Prismatic Shape Batteries

In a preferable embodiment, the battery is an approximately rectangular shape with a height of 48.5 mm, a length of 26.5 mm and a width of 17.5 mm. Preferably, the battery has a nominal voltage of 9 volts. Preferably, the battery is rechargeable.

In a further embodiment, the disclosure relates to a rectangular battery comprising a cell according to any previous embodiment of any previous aspect. Preferably, the rectangular batter is selected from: a 4.5-volt lantern battery; a 6-volt (spring or screw fitting) lantern battery; a 7.5-volt lantern battery; a 12-volt lantern battery; or a 9-volt battery.

### Cylindrical-Shape Batteries

Cylindrical-shape lithium-ion secondary batteries typically include a spirally wound electrode assembly which includes a cathode and an anode spirally wound with a separator in between, and a pair of insulating plates in a substantially hollow cylindrical-shaped battery can. In a preferable embodiment, the battery is a cylindrical battery with a 17 mm diameter and a 34.5 mm height. Preferably, the battery has a nominal voltage of 3.6 volts. More preferably, the battery has a nominal voltage of 3.6 volts and a capacity of 700 mAh. Preferably, the battery is rechargeable.

In a preferable embodiment, the battery has a cylindrical shape with a 15.6 mm diameter and a length of 27 mm. Preferably, the battery has a nominal voltage of 3.6 volts. More preferably, the battery has a nominal voltage of 3.6 volts and a capacity of 600 or 800 mAh. Preferably, the battery is rechargeable.

In a preferable embodiment, the battery is a cylindrical battery with a 17 mm diameter and a 34.5 mm height. Preferably, the battery has a nominal voltage of 3.6 volts. More preferably, the battery has a nominal voltage of 3.6 volts and capacity of 700 mAh.

### Double-Cylinder-Shaped Batteries

In a preferable embodiment, the battery has a double cylinder shape, with a height of 52.20 mm, a length of 28.05 mm and a width of 14.15 mm. More preferably, the battery has a nominal voltage of 3.6 volts and capacity of 1,300 mAh.

### Button-Shaped Batteries

Button-shaped cells, also commonly referred to as coin-shaped cells, are thin compared to their diameter. In a preferred embodiment, the battery is button-shaped with a 9.5 mm diameter and a 2.7 mm height. Preferably, the battery has a nominal voltage of 3.0 volts, 3.2 volts, 3.4 volts, or 3.6 volts. More preferably, the battery has a nominal voltage of 3.0 volts and a capacity for a constant discharge down to 2.0 volts per cell of 30 mAh.

In a preferred embodiment, the battery is button-shaped with a 10 mm diameter and a 2.5 mm height. Preferably, the battery has a nominal voltage of 3.0 volts. More preferably, the battery has a nominal voltage of 3.0 volts, 3.2 volts, 3.4 volts, or 3.6 volts. and a capacity for a constant discharge down to 2.0 volts per cell of 30 mAh.

In a preferred embodiment, the battery is button-shaped with a 11.5 mm diameter and a 3.0 mm height. Preferably, the battery has a nominal voltage of 3.0 volts. More preferably, the battery has a nominal voltage of 3.0 volts, 3.2 volts, 3.4 volts, or 3.6 volts. and a capacity for a constant discharge down to 2.0 volts per cell of 70 mAh.

In a preferred embodiment, the battery is button-shaped with a 11 mm diameter and a 10.8 mm height. Preferably, the battery has a nominal voltage of 3.0 volts, 3.2 volts, 3.4 volts, or 3.6 volts. More preferably, the battery has a nominal voltage of 3.0 volts, 3.2 volts, 3.4 volts, or 3.6 volts, and a capacity for a constant discharge down to 2.0 volts per cell of 160 mAh.

In a preferred embodiment, the battery is button-shaped with a 12.5 mm diameter and a 1.6 mm height. Preferably, the battery has a nominal voltage of 3.0 volts. More preferably, the battery has a nominal voltage of 3.0 volts, 3.2 volts, 3.4 volts, or 3.6 volts, and a capacity for a constant discharge down to 2.0 volts per cell of 25 mAh.

In a preferred embodiment, the battery is button-shaped with a 12.5 mm diameter and a 2.0 mm height. Preferably, the battery has a nominal voltage of 3.0 volts. More preferably, the battery has a nominal voltage of 3.0 volts and a capacity for a constant discharge down to 2.0 volts per cell of from 35 to 40 mAh.

In a preferred embodiment, the battery is button-shaped with a 12.5 mm diameter and a 2.5 mm height. Preferably, the battery has a nominal voltage of 3.0 volts, 3.2 volts, 3.4 volts, or 3.6 volts. More preferably, the battery has a nominal voltage of 3.0 volts and a capacity for a constant discharge down to 2.0 volts per cell of 50 mAh.

In a preferred embodiment, the battery is button-shaped with a 16 mm diameter and a 1.6 mm height. Preferably, the battery has a nominal voltage of 3.0 volts. More preferably, the battery has a nominal voltage of 3.0 volts, 3.2 volts, 3.4 volts, or 3.6 volts, and a capacity for a constant discharge down to 2.0 volts per cell of from 50 to 55 mAh.

In a preferred embodiment, the battery is button-shaped with a 16 mm diameter and a 2.0 mm height. Preferably, the battery has a nominal voltage of 3.0 volts, 3.2 volts, 3.4 volts, or 3.6 volts. More preferably, the battery has a nominal voltage of 3.0 volts and a capacity for a constant discharge down to 2.0 volts per cell of from 75 to 78 mAh.

In a preferred embodiment, the battery is button-shaped with a 16 mm diameter and a 3.2 mm height.

Preferably, the battery has a nominal voltage of 3.0 volts, 3.2 volts, 3.4 volts, or 3.6 volts.

More preferably, the battery has a nominal voltage of 3.0 volts and a capacity for a constant discharge down to 2.0 volts per cell of 140 mAh.

In a preferred embodiment, the battery is button-shaped with a 20 mm diameter and a 1.2 mm height. Preferably, the battery has a nominal voltage of 3.0 volts, 3.2 volts, 3.4 volts, or 3.6 volts. More preferably, the battery has a nominal voltage of 3.0 volts and a capacity for a constant discharge down to 2.0 volts per cell of 55 mAh.

In a preferred embodiment, the battery is button-shaped with a 20 mm diameter and a 1.6 mm height. Preferably, the battery has a nominal voltage of 3.0 volts, 3.2 volts, 3.4 volts, or 3.6 volts. More preferably, the battery has a nominal voltage of 3.0 volts, 3.2 volts, 3.4 volts, or 3.6 volts, and a capacity for a constant discharge down to 2.0 volts per cell of 90 mAh. In a preferred embodiment, the battery is button-shaped with a 20 mm diameter and a 2.0 mm height. Preferably, the battery has a nominal voltage of 3.0 volts. More preferably, the battery has a nominal voltage of 3.0 volts and a capacity for a constant discharge down to 2.0 volts per cell of from 115 to 125 mAh.

In a preferred embodiment, the battery is button-shaped with a 20 mm diameter and a 2.5 mm height. Preferably the, the battery has a nominal voltage of 3.0 volts. More preferably the, the battery has a nominal voltage of 3.0 volts and a capacity for a constant discharge down to 2.0 volts per cell of from 160 to 165 mAh.

In a preferred embodiment, the battery is button-shaped with a 20 mm diameter and a 3.2 mm height. Preferably the, the battery has a nominal voltage of 3.0 volts. More preferably, the battery has a nominal voltage of 3.0 volts and a capacity for a constant discharge down to 2.0 volts per cell of 225 mAh. Preferably, the battery has a maximum discharge current of 3 mA. Preferably, the battery has a maximum pulse discharge current of 15 mA. Preferably, the battery has a mass of less than 3.0 g, more preferably less than 2.9 g, even more preferably of less than 2.8 g.

In a preferable embodiment, the battery is button-shaped with a 20 mm diameter and a 4.0 mm height. Preferably, the battery has a nominal voltage of 3.0 volts, 3.2 volts, 3.4 volts, or 3.6 volts. More preferably, the battery has a nominal voltage of 3.0 volts, 3.2 volts, 3.4 volts, or 3.6 volts, and a capacity for a constant discharge down to 2.0 volts per cell of 280 mAh.

In a preferable embodiment, the battery is button-shaped with a 23 mm diameter and a 2.0 mm height. Preferably, the battery has a nominal voltage of 3.0 volts, 3.2 volts, 3.4 volts, or 3.6 volts. More preferably, the battery has a nominal voltage of 3.0 volts, 3.2 volts, 3.4 volts, or 3.6 volts and a capacity for a constant discharge down to 2.0 volts per cell of 350 mAh.

In a preferable embodiment, the battery is button-shaped with a 23 mm diameter and a 2.0 mm height. Preferably, the battery has a nominal voltage of 3.0 volts, 3.2 volts, 3.4 volts, or 3.6 volts. More preferably, the battery has a nominal voltage of 3.0 volts, 3.2 volts, 3.4 volts, or 3.6 volts, and a capacity for a constant discharge down to 2.0 volts per cell of from 110-175 mAh.

In a preferable embodiment, the battery is button-shaped with a 23 mm diameter and a 2.5 mm height. Preferably, the battery has a nominal voltage of 3.0 volts. More preferably, the battery has a nominal voltage of 3.0 volts, 3.2 volts, 3.4 volts, or 3.6 volts and a capacity for a constant discharge down to 2.0 volts per cell of from 165 to 210 mAh. In a preferred embodiment, the battery is button-shaped with a 23 mm diameter and a 3.0 mm height.

Preferably, the battery has a nominal voltage of 3.0 volts, 3.2 volts, 3.4 volts, or 3.6 volts. More preferably, the battery has a nominal voltage of 3.0 volts and a capacity for a constant discharge down to 2.0 volts per cell of 265 mAh.

In a preferable embodiment, the battery is button-shaped with a 23 mm diameter and a 3.5 mm height. Preferably, the battery has a nominal voltage of 3.0 volts. More preferably, the battery has a nominal voltage of 3.0 volts and a capacity for a constant discharge down to 2.0 volts per cell of 165 mAh.

In a preferable embodiment, the battery is button-shaped with a 23 mm diameter and a 5.4 mm height. Preferably, the battery has a nominal voltage of 3.0 volts, 3.2 volts, 3.4 volts, or 3.6 volts. More preferably, the battery has a nominal voltage of 3.0 volts, 3.2 volts, 3.4 volts, or 3.6 volts, and a capacity for a constant discharge down to 2.0 volts per cell of 560 mAh. In a preferable embodiment, the battery is button-shaped with a 24 mm diameter and a 1.2 mm height. Preferably, the battery has a nominal voltage of 3.0 volts. More preferably, the battery has a nominal voltage of 3.0 volts and a capacity for a constant discharge down to 2.0 volts per cell of 100 mAh. In a preferable embodiment, the battery is button-shaped with a 24 mm diameter and a 3.0 mm height. Preferably, the battery has a nominal voltage of 3.0 volts. More preferably, the battery has a nominal voltage of 3.0 volts and a capacity for a constant discharge down to 2.0 volts per cell of from 270 to 290 mAh.

In a preferable embodiment, the battery is button-shaped with a 24 mm diameter and a 5.0 mm height. Preferably, the battery has a nominal voltage of 3.0 volts, 3.2 volts, 3.4 volts, or 3.6 volts. More preferably, the battery has a nominal voltage of 3.0 volts, 3.2 volts, 3.4 volts, or 3.6 volts, and a capacity for a constant discharge down to 2.0 volts per cell of from 610 to 620 mAh.

In a preferable embodiment, the battery is button-shaped with a 24 mm diameter and a 7.7 mm height. Preferably, the battery has a nominal voltage of 3.0 volts, 3.2 volts, 3.4 volts, or 3.6 volts. More preferably, the battery has a nominal voltage of 3.0 volts, 3.2 volts, 3.4 volts, or 3.6 volts, and a capacity for a constant discharge down to 2.0 volts per cell of 1000 mAh. In a preferable embodiment, the battery is button-shaped with a 26.2 mm diameter and a 1.67 mm height.

In a preferable embodiment, the battery is button-shaped with a 30 mm diameter and a 3.2 mm height. Preferably, the battery has a nominal voltage of 3.0 volts, 3.2 volts, 3.4 volts, or 3.6 volts. More preferably, the battery has a nominal voltage of 3.0 volts and a capacity for a constant discharge down to 2.0 volts per cell of from 500 to 560 mAh.

In a preferable embodiment, the battery is button-shaped with a 30 mm diameter and a 3.2 mm height. Preferably, the battery has a nominal voltage of 3.0 volts, 3.2 volts, 3.4 volts, or 3.6 volts. More preferably the battery has a nominal voltage of 3.0 volts, 3.2 volts, 3.4 volts, or 3.6 volts and a capacity for a constant discharge down to 2.0 volts per cell of from 500 to 560 mAh.

### Flat or Pouch Shape

The design of the individual batteries around the high energy positive electrode active material can provide for batteries with a high capacity within a practical format. Pouch batteries are generally approximate rectangular parallelepipeds, excluding the connection tabs and other potential features around the edges, characterized by a thickness (t) and a planar area with a width (w) and a height (h) in which the thickness is generally significantly less than the linear dimensions (width and height) defining the planar area (w·h). In particular, the batteries can have a thickness between about 7 mm and about 18 mm. The area of the pouch battery can range from about 25,000 mm2 to about 50,000 mm2, in which the linear dimensions of width and height defining the area generally range from about 50 mm to about 750 mm.

The resultant individual battery generally can have a discharge energy density of at least about 160 Wh/kg when discharged from 4.5V to 2.0V. In some advantageous embodiments, the resultant battery can have a discharge energy density of at least about 200 Wh/kg, in other embodiments from about 250 Wh/kg to about 400 Wh/kg when discharged from 4.5V to 2.0V. In further embodiments, the battery can have a volumetric discharge energy density of at least about 300 Wh/l. In other advantageous embodiments, the resultant battery can have a volumetric discharge energy density of at least about 500 Wh/l to 1150 Wh/l when discharged from 4.5V to 2.0V.

In the above-described embodiments, prismatic type, cylindrical types, laminate film type, coin type or a button type or and batteries in spirally wound configuration are described. However, the battery according to the invention may be applicable to any other shape, wherein the battery element has any other configuration such as a laminate configuration.

### Use of Cell or Battery According to any Previous Aspect

An additional aspect of the disclosure is the use of the cell or the battery according to any previous aspect or embodiment of the disclosure above as an energy storage and/or release device.

The term “energy storage and/or release device” herein is understood to mean a secondary battery, including an electrode assembly of a cathode/separator/anode structure mounted in a suitable battery case. Such batteries include lithium-ion secondary batteries, which are excelling in providing high energy density, and a high capacity; and their use in secondary battery modules comprising a plurality of secondary batteries, which are typically connected in series with each other to form a battery pack that can be incorporated into a casing to form the module.

### DETAILED DESCRIPTION OF THE FIGURES

The disclosure will now be discussed with reference to the figures, which show preferred exemplary embodiments of the subject disclosure.

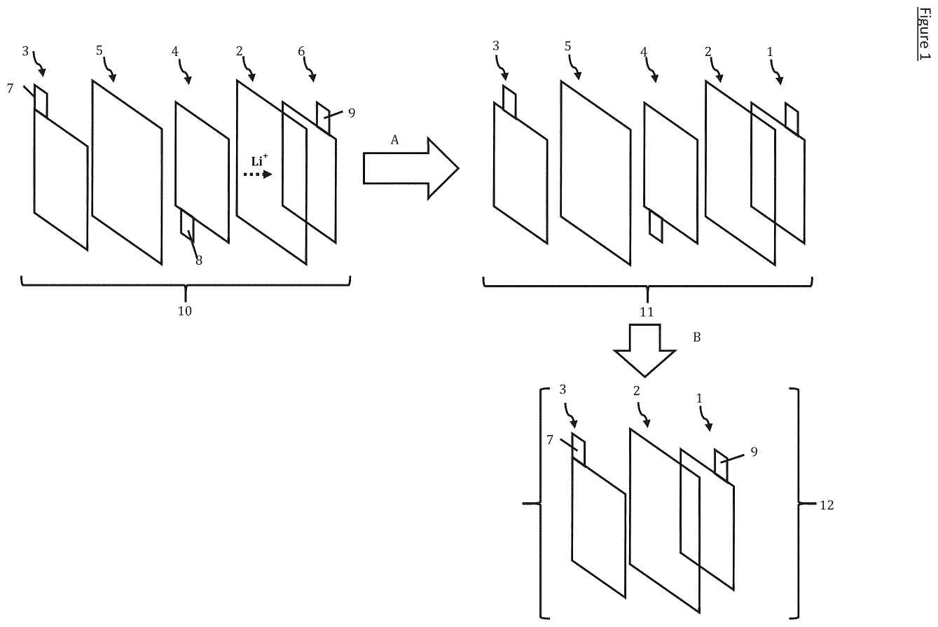

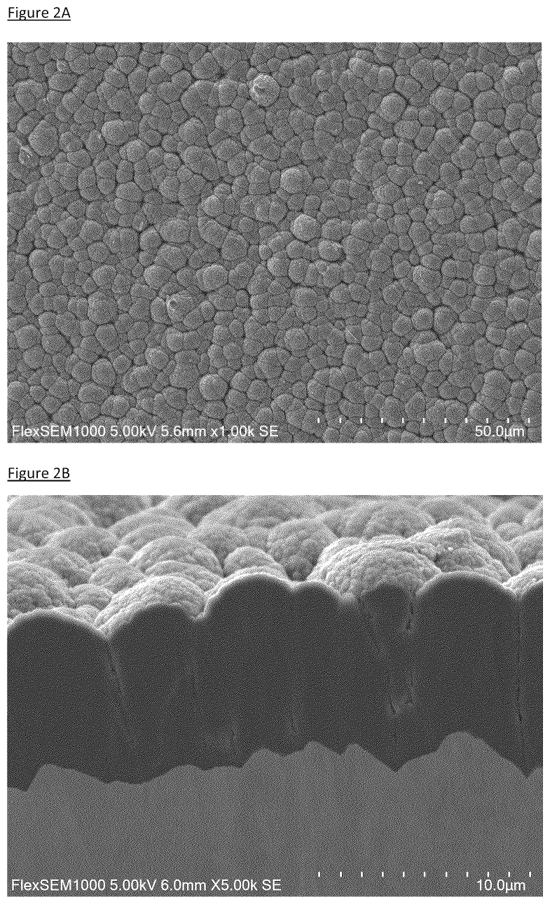

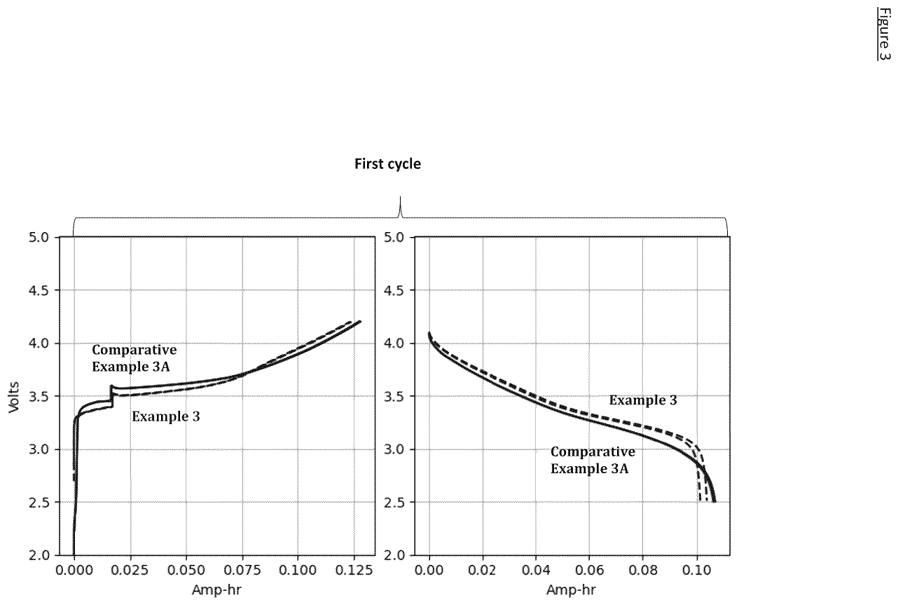

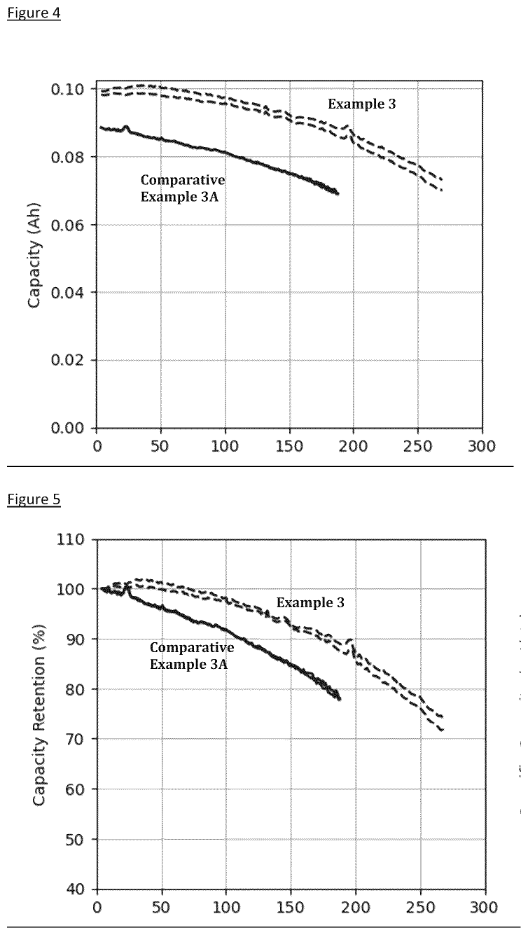

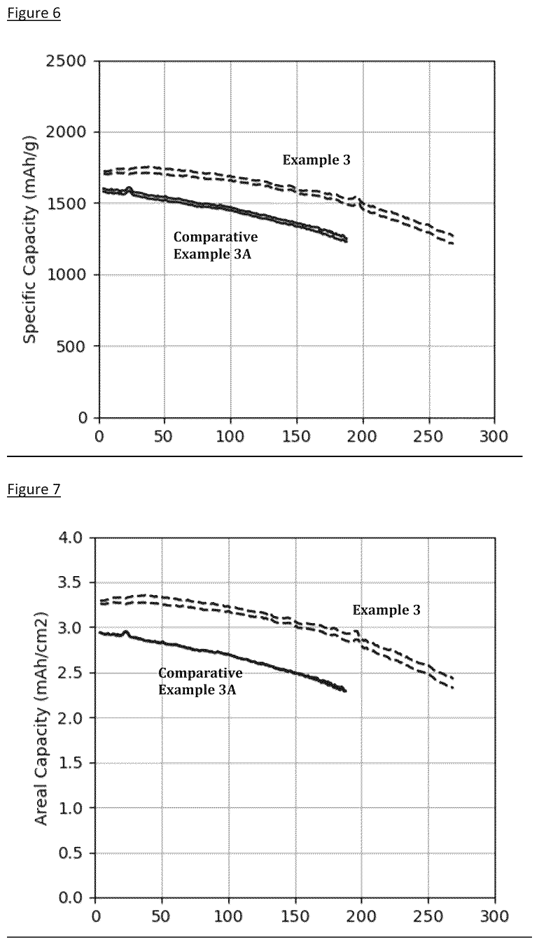

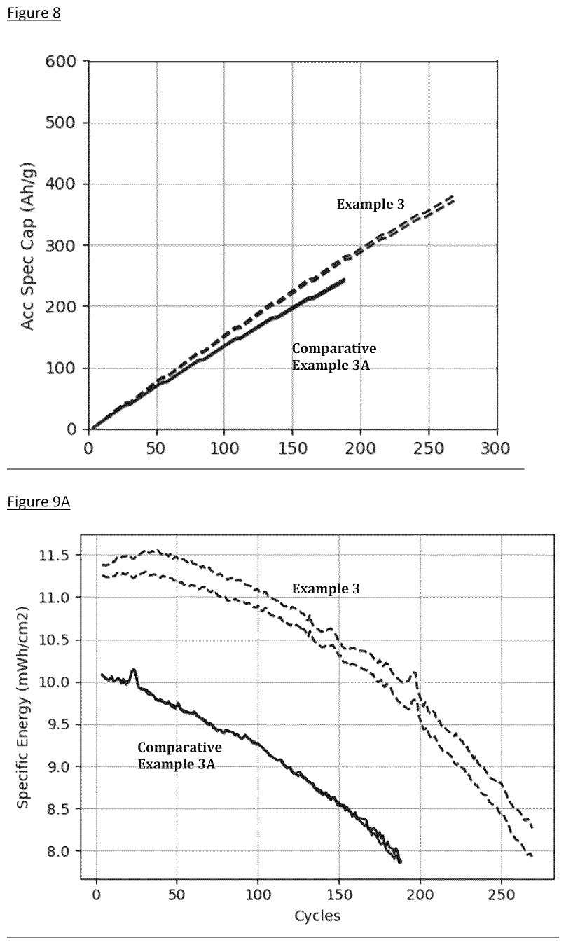

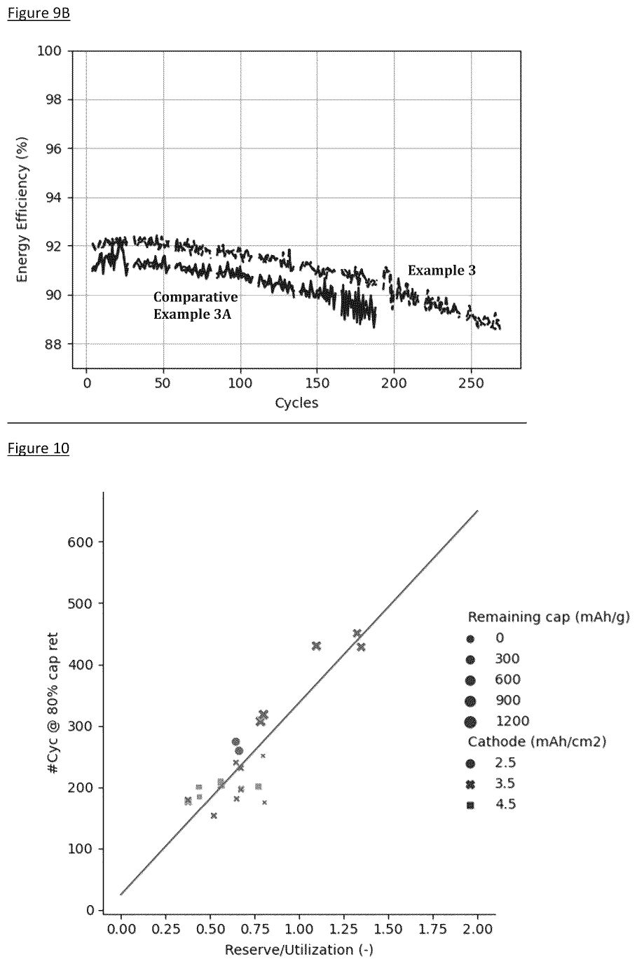

FIG. 1 depicts schematically a method of manufacturing a lithium-ion cell according to the present disclosure. The figure shows a preferred embodiment of the subject process, for building a lithium-ion cell, such as a pouch cell (10) by stacking the following components for the prelithiation step: Firstly, (i) an anode material is provided, as well as a (ii) a ceramic-coated separator (2), e.g. a polymeric polyolefin coated on both sides with a layer of alumina; (iii) a sacrificial cathode material (4), e.g. a lithium source, such as a lithium nickel manganese cobalt oxide material; a (iv) a plastic divider (5); and (v) a non-sacrificial cathode material (3). A silicon layer of the anode material (6) is orientated facing the separator (2). Both the sacrificial cathode (4) and the silicon anode (6) are then connected to an external circuit by electrode tabs (8,9) in an electrically conductive manner to the electrodes (4, 6). The tabbed and stacked unit is enveloped within a commercially available enveloping material and sealed on three sides. A commercially sourced electrolyte is added to the envelop (10) under a dry atmosphere, and then the envelop is sealed under reduced pressure.

The thus formed cell (10) is then charged to a suitable rate, e.g. 250 mAh/g at 0.2 C to afford a partially-charged enveloped cell (11) comprising a pre-lithiated silicon anode (1).

Then the sacrificial cathode (4) is disconnected from the external circuit, and sacrificial cathode (4) and plastic divider (5) are removed from the partially-charged cell (11). Then, a non-sacrificial cathode (3) is provided which is connected to an external circuit by an electrode tab (7) by conventional means to the electrode (3). A separator (2) is provided to separate the pre-lithiated anode material (1) and the non-sacrificial cathode (3). The residual electrolyte then provides an electrochemical bridge between the pre-lithiated anode material (1) and the non-sacrificial cathode (3) through the separator (2). The resultant enveloped cell (12) is then sealed, typically under reduced pressure, to obtain the desired lithium cell.

FIG. 2A is a top-down scanning electron microscopy image obtained of an anode comprising a silicon layer in which the silicon layer comprises a plurality of columnar structures. The scale bar is equivalent to 50 μm, with each graduation equivalent to 5 μm.

FIG. 2B is a cross-sectional scanning electron microscopy image obtained of an anode comprising a silicon layer in which the silicon layer comprises a plurality of columnar structures. The scale bar is equivalent to 10 μm, with each graduation equivalent to 1 μm.

FIG. 3 is a graph of the first charge and discharge cycle properties observed for cells according to the invention (Example 3, dashed-line) and comparative cells (Comparative Example 3A, solid-line). Example 3, the cell according to the invention, exhibited a lower charge voltage and higher discharge voltage than Comparative Example 3A. Therefore, Example 3 exhibited a higher energy efficiency than Comparative Example 3A.

FIG. 4 is a graph of the capacity (Ah) against cycle number experimentally obtained for a material according to the present disclosure (Example 3, dashed-lines) and a comparative example (Example 3A, solid-lines). The lithium-ion cells according to the present disclosure exhibited improved capacity comparted to the comparative example.

FIG. 5 is a graph of capacity retention (%) against cycle number experimentally obtained for a material according to the present disclosure (Example 3) and a comparative example (Example 3A). The lithium-ion cells according to the present disclosure exhibited improved capacity retention comparted to the comparative example.

FIG. 6 is a graph of specific capacity (Ah/g) against cycle number experimentally obtained for a material according to the present disclosure (Example 3, dashed-lines) and a comparative example (Example 3A, two nearly co-incident solid-lines). The lithium-ion cells according to the present disclosure exhibited improved specific capacity comparted to the comparative example.

FIG. 7 is a graph of areal capacity (mAh/cm²) against cycle number experimentally obtained for a material according to the present disclosure (Example 3, dashed-lines) and a comparative example (Example 3A, two nearly co-incident solid-lines). The lithium-ion cells according to the present disclosure exhibited improved areal capacity comparted to the comparative example.

FIG. 8 is a graph of accumulated specific capacity (Ah/g) against cycle number experimentally obtained for a material according to the present disclosure (Example 3, dashed-lines) and a comparative example (Example 3A, two nearly co-incident solid lines). The accumulated specific capacity until 80% beginning-of-life capacity is improved by a factor of approximately 1.4 for lithium-ions according to the present disclosure versus the comparative example.

FIG. 9A is a graph of specific energy (mWh/cm²) against cycle number experimentally obtained for a material according to the present disclosure (Example 3, dashed-lines) and a comparative example (Example 3A, two nearly co-incident solid-lines). The lithium-ion cell according to the present disclosure exhibited an increase of approximately 13% in the specific energy compared to the comparative example.

FIG. 9B is a graph of energy efficiency (%) against cycle number experimentally obtained for a material according to the present disclosure (Example 3, upper set of data points) and a comparative example (Example 3A, lower set of data points). For nearly every cycle, the material according to the present invention possessed higher energy efficiency than the comparative material. The lithium-ion cell according to the present invention exhibited an improvement of 1% in energy efficiency compared to the comparative example.

FIG. 10 is a graph of: (i) the number of charge cycles that can be performed until only 80% of the initial capacity of the full cell can be obtained [“#Cycles @ 80% capacity retention” in Table 1]; against (ii) the lithium reserve divided by the lithium utilization. The lithium reserve is an indirect measure of the degree of pre-lithiation, with a higher number corresponding to a higher degree of pre-lithiation. In this example a lithium reserve value of 686 mAh/g, corresponds to 19% of the theoretical maximum. The lithium reserve is the lithium content in the silicon in the discharged state of the full cell normalized to the mass of silicon in the silicon anode. Lithium utilization is the amount of lithium being used during cycling normalized to the mass of silicon in the silicon anode. An advantageous linear relationship is observed between: (i) the number of charge cycles that can be performed until only 80% of the initial capacity of the full cell can be obtained; against (ii) the lithium reserve divided by the lithium utilization.

### LIST OF REFERENCE NUMERALS

1 pre-lithiated silicon anode
2 separator
3 non-sacrificial cathode
4 sacrificial lithium-ion cathode
5 divider
6 silicon anode
7 non-sacrificial cathode electrode tab
8 sacrificial cathode electrode tab
9 (pre-lithiated) silicon anode electrode tab
10 first intermediate cell
11 second intermediate cell
12 lithium ion cell
A charging the intermediate lithium ion cell (10)
B removing the sacrificial lithium-ion cathode (4) and the divider (5)

### EXAMPLES

The following, non-limiting examples illustrate the products and processes according to the disclosure.

### Example 1—Preparation of a Silicon Anode Suitable for Lithiation [Silicon with a Columnar Morphology on the Nanoscale]

A roll of roughened copper foil current collector material (Sa 0.51 μm, Sq 0.65 μm, Sz 5.9 μm, Sds 0.77 μm⁻², Ssc 16.2 μm-2, Sdq 2.1 μm, Sdr 157% as determined by standard method ISO 25178) was fed into a plasma enhanced chemical vapour deposition (PECVD) device that comprises an unwinding chamber, two deposition chambers and a rewinding chamber. These chambers are all connected and are normally operated under vacuum (0.05-0.2 mbar). The foil was transported by a system of tension rolls and two heated drums that control the temperature of the foil. A first silicon layer was deposited onto the same side of the copper substrate by PECVD, at a substrate temperature of from 100 to 300° C. In this process magnetron radiation with a frequency of 2.45 GHz was used to excite a gas mixture containing a silicon precursor gas and support gases. Silane (SiH₄) was the source of silicon, whereas argon (Ar) and hydrogen (H₂) were added to stabilize the plasma, influence the material structure and improve the deposition rate. The gas was injected via “gas showers” that distribute the gas evenly.

The magnetron (microwave) radiation was introduced into the vacuum chamber by means of an antenna. To ensure a homogeneous plasma, both sides of the antenna are connected to a magnetron radiation source. Magnetron heads are thus located on each side of the antenna. These magnetron heads are connected to the antenna. Gases are injected via the gas showers proximal to the magnetron heads. The antenna is protected from the reactive environment by a quartz tube. The plasma is confined by a magnetic field that is generated by an array of permanent magnets.

The production rate of silicon was determined by the process conditions, power input per source, and by the number of microwave sources in operation. The gas flow was scaled with the MW power input, which was 800-6000 W/m. Ten antennas or sources of power input were used.

FIG. 2A is top-down Scanning Electron Microscopy (SEM) image of the material obtained. FIG. 2B is a cross-sectional Scanning Electron Microscopy (SEM) image of the material obtained.

Cross-sectional SEM (FIG. 2B) established that the deposited silicon layer had a thickness of from 8 to 9 μm. BET analysis determined that the material had a surface area of 79.9 m²/g a porosity of 15.73% and an average pore size of 4.01 nm. XRF analysis revealed a mass loading of 1.27-1.29 mg/cm². The deposited material had a CIELAB lightness value L* of from 42.07 to 42.98.

### Example 2—Electrochemical Pre-Lithiation of a Silicon Anode

A pouch cell was built by stacking (i) the anode material as prepared above [Example 1], (ii) a ceramic-coated separator (a 12 μm polymer polypropylene coated on both sides with a 2 μm layer of alumina sourced from Gelon LIB Group, China) and (iii) a sacrificial cathode material (3.5 Ah/cm² lithium nickel manganese cobalt oxide NMC 622, commercially available from TOP Material). The silicon layer was orientated facing the separator. Both the cathode and anode were connected to an external circuit by electrode tabs that were welded by conventional means to the electrodes by conventional means. The tabbed and stacked unit was pouched within a commercially available laminated aluminium pouching material, which was sealed on three sides. The commercially sourced electrolyte [a solution of LiPF₆ (1 M), in a mixture of 4-fluoro-1,3-dioxolan-2-one (Fluoroethylene carbonate, FEC) and diethyl carbonate (DEC) in a 3:7 volumetric ratio, which additionally contained 2 wt. % of vinylene carbonate (VC) and 2 wt. % adiponitrile (AN)] was added to the laminated aluminium pouch under a dry atmosphere, and then vacuum sealed.

The pouch cell was charged to 250 mAh/g (7% of theoretical maximum) at a rate of approximately 0.2 C.

The pouch cell was then disconnected and the pre-lithiated anode isolated.

### Example 3—Method of Manufacturing a Cell with Pre-Lithiated Silicon Anode Material

The process is as schematically depicted in FIG. 1.

A pouch cell (10) was built by stacking: (i) the anode material as prepared above (6) [Example 1], (ii) a ceramic-coated separator (2) (a 12 μm polymer polypropylene coated on both sides with a 2 μm layer of alumina sourced from Gelon LIB Group, China); (iii) a sacrificial cathode material (4) (3.5 Ah/cm² lithium nickel manganese cobalt oxide NMC 622, commercially available from TOP Material); (iv) a plastic divider (5); and (v) a non-sacrificial cathode material (3) (3.5 Ah/cm² lithium nickel manganese cobalt oxide NMC 622, commercially available from TOP Material). The silicon layer of the anode material (6) was orientated facing the separator (2). Both the sacrificial cathode (4) and the silicon anode (6) were connected to an external circuit by electrode tabs (8,9) that were welded by conventional means to the electrodes (4, 6). The tabbed and stacked unit was pouched within a commercially available laminated aluminium pouching material, which was sealed on three sides. The commercially sourced electrolyte [a solution of LiPF₆ (1 M in a mixture of 4-fluoro-1,3-dioxolan-2-one (Fluoroethylene carbonate, FEC) and diethyl carbonate (DEC) in a 3:7 volumetric ratio, which additionally contained 2 wt. % of vinylene carbonate and 2 wt. % adiponitrile (AN)] was added to the laminated aluminium pouch (10) under a dry atmosphere, and then vacuum sealed.

The pouch cell (10) was charged to 250 mAh/g (7% of theoretical maximum) at 0.2 C to afford the partially-charged pouch cell (11) comprising a pre-lithiated silicon anode (1).

The sacrificial cathode (4) was disconnected from the external circuit. The sacrificial cathode (4) and the plastic divider (5) were removed from the partially-charged pouch cell (11). The non-sacrificial cathode (3) was connected to an external circuit by an electrode tab (7) that was welded by conventional means to the electrode (3). The separator (2) separated the pre-lithiated anode material (1) and the non-sacrificial cathode (3). The residual electrolyte electrochemically bridged the pre-lithiated anode material (1) and the non-sacrificial cathode (3) through the separator (2). The resultant pouch cell (12) was then vacuum sealed.

### Comparative Example 3A—Method of Manufacturing a Comparative Cell

A pouch cell was built by stacking: (i) the anode material as prepared above [Example 1], (ii) a ceramic-coated separator (a 12 μm polymer polypropylene coated on both sides with a 2 μm layer of alumina sourced from Gelon LIB Group, China); (iii) a cathode material (3.5 Ah/cm² lithium nickel manganese cobalt oxide NMC 622, commercially available from TOP Material). The silicon layer was orientated facing the separator. Both the cathode and anode were connected to an external circuit by electrode tabs that were welded by conventional means to the electrodes. The tabbed and stacked unit was pouched within a commercially available laminated aluminium pouching material, which was sealed on three sides. The commercially sourced electrolyte [a solution of LiPF₆ (1 M), in a mixture of 4-fluoro-1,3-dioxolan-2-one (Fluoroethylene carbonate, FEC) and diethyl carbonate (DEC) in a 3:7 volumetric ratio, which additionally contained 2 wt. % of vinylene carbonate and 2 wt. % adiponitrile (AN)] was added to the laminated aluminium pouch under a dry atmosphere, and then vacuum sealed.

The pouch cell was not charged before conducting any subsequent tests.

### Example 3B—Method of Manufacturing a Cell with Pre-Lithiated Silicon Anode Material [2.5 Ah/Cm² Cathode]

A pouch cell was built by stacking: (i) the anode material as prepared above [Example 1], (ii) a ceramic-coated separator (a 12 μm polymer polypropylene coated on both sides with a 2 μm layer of alumina sourced from Gelon LIB Group, China); (iii) a sacrificial cathode material (2.5 Ah/cm² lithium nickel manganese cobalt oxide NMC 622, commercially available from TOP Material); (iv) a plastic divider; and (v) a non-sacrificial cathode material (2.5 Ah/cm² lithium nickel manganese cobalt oxide NMC 622, commercially available from TOP Material). The silicon layer was orientated facing the separator. Both the sacrificial cathode and anode were connected to an external circuit by electrode tabs that were welded by conventional means to the electrodes. The tabbed and stacked unit was pouched within a commercially available laminated aluminium pouching material, which was sealed on three sides. The commercially sourced electrolyte [a solution of LiPF₆ (1 M in a mixture of 4-fluoro-1,3-dioxolan-2-one (Fluoroethylene carbonate, FEC) and diethyl carbonate (DEC) in a 3:7 volumetric ratio, which additionally contained 2 wt. % of vinylene carbonate and 2 wt. % adiponitrile (AN)] was added to the laminated aluminium pouch under a dry atmosphere, and then vacuum sealed.

The pouch cell was pre-lithiated to between 0 mAh/g and 1200 mAh/g (⅓ of theoretical maximum) and then charged-cycled between 0 and 1200 mAh/g at a rate of 0.1 C for the initial cycle and tested at a rate of 0.2 C for subsequent cycles.

The sacrificial cathode disconnected from the external circuit. The sacrificial cathode and the plastic divider were removed from the pouch cell. The non-sacrificial cathode was connected to an external circuit by an electrode tab that was welded by conventional means to the electrode. The separator separated the anode material and the non-sacrificial cathode. The residual electrolyte electrochemically bridged the pre-lithiated anode material and the non-sacrificial cathode through the separator. The pouch cell was then vacuum sealed.

### Example 3C—Method of Manufacturing a Cell with Pre-Lithiated Silicon Anode Material [3.5 Ah/Cm² Cathode]

A pouch cell was built by stacking: (i) the anode material as prepared above [Example 1], (ii) a ceramic-coated separator (a 12 μm polymer polypropylene coated on both sides with a 2 μm layer of alumina sourced from Gelon LIB Group, China); (iii) a sacrificial cathode material (2.5 Ah/cm² lithium nickel manganese cobalt oxide NMC 622, commercially available from TOP Material); (iv) a plastic divider; and (v) a non-sacrificial cathode material (3.5 mAh/cm² lithium nickel manganese cobalt oxide NMC 622, commercially available from TOP Material). The silicon layer was orientated facing the separator. Both the sacrificial cathode and anode were connected to an external circuit by electrode tabs that were welded by conventional means to the electrodes. The tabbed and stacked unit was pouched within a commercially available laminated aluminium pouching material, which was sealed on three sides. The commercially sourced electrolyte [a solution of LiPF₆ (1 M in a mixture of 4-fluoro-1,3-dioxolan-2-one (Fluoroethylene carbonate, FEC) and diethyl carbonate (DEC) in a 3:7 volumetric ratio, which additionally contained 2 wt. % of vinylene carbonate and 2 wt. % adiponitrile (AN)] was added to the laminated aluminium pouch under a dry atmosphere, and then vacuum sealed.

The pouch cell was pre-lithiated to between 0 mAh/g and 1200 mAh/g (⅓ of theoretical maximum) and then charged-cycled between 0 and 1200 mAh/g at a rate of 0.1 C for the initial cycle and tested at a rate of 0.2 C for subsequent cycles.

The sacrificial cathode disconnected from the external circuit. The sacrificial cathode and the plastic divider were removed from the pouch cell. The non-sacrificial cathode was connected to an external circuit by an electrode tab that was welded by conventional means to the electrode. The separator separated the anode material and the non-sacrificial cathode. The residual electrolyte electrochemically bridged the pre-lithiated anode material and the non-sacrificial cathode through the separator. The pouch cell was then vacuum sealed.

### Example 3D—Method of Manufacturing a Cell with Pre-Lithiated Silicon Anode Material [4.5 mAh/Cm² Cathode]

A pouch cell was as in Example 3C, differing only in that the sacrificial cathode and non-sacrificial cathode were 4.5 mAh/cm 2 lithium nickel manganese cobalt oxide NMC 622 cathodes, commercially available from TOP Material.

The pouch cell was pre-lithiated to between 0 mAh/g and 1200 mAh/g (⅓ of theoretical maximum) and then charged-cycled between 0 and 1200 mAh/g at a rate of 0.1 C for the initial cycle and tested at a rate of 0.2 C for subsequent cycles.

The sacrificial cathode disconnected from the external circuit. The sacrificial cathode and the plastic divider were removed from the pouch cell. The non-sacrificial cathode was connected to an external circuit by an electrode tab that was welded by conventional means to the electrode. The separator separated the anode material and the non-sacrificial cathode. The residual electrolyte electrochemically bridged the pre-lithiated anode material and the non-sacrificial cathode through the separator. The pouch cell was then vacuum sealed.

### Example 4—First-Cycle Analysis

The pouched cells prepared according to Example 3 and Comparative Example 3A were charged and then discharged to 1700 mAh/g at 0.5 C. The results are depicted in FIG. 3 (charge on left-hand side, discharge on right-hand side).

Example 3, the cell according to the invention, exhibited a lower charge voltage and higher discharge voltage than Comparative Example 3A. Therefore, Example 3 exhibited a higher energy efficiency than Comparative Example 3A.

### Example 5—Cycle Life/Capacity Retention Analysis

Cells according to the disclosure prepared according to Example 3 and comparative cells prepared according to Example 3A were evaluated for their capacity retention properties. The cycling conditions used were C/2 rate, 3 V to 4.2 V (Constant Voltage [CV] step at 4.2 V until C/20 rate) at 25° C.

The results are presented in FIGS. 4, 5, 6, 7 and 8.

The results demonstrated that lithium-ion cells according to the disclosure demonstrated that lithium-ion cells according to the present disclosure:
retained high areal capacity for significantly more charge cycles than the comparative example;
retained high capacity retention for significantly more charge cycles that the comparative example;
retained high specific capacity for significantly more charge cycles that the comparative example;
retained high areal capacity for significantly more charge cycles that the comparative example and
retained a substantially linear accumulated specific capacity relationship for significantly more charge cycles.

Thus, lithium-ion cells according to the present disclosure demonstrate improved capacity retention, and hence cycle-life, compared to lithium-ion cells made using conventional anodes. The number of cycles required for the accumulated specific capacity, which in this instance is a measure of how much capacity is delivered normalised to the mass of silicon, falls to 80% of the beginning-of-life capacity is approximately 40% higher for lithium-ion cells according to the present disclosure that for lithium-ion cells made using conventional means.

### Example 6—Cycle Life/Specific Energy

Cells according to the disclosure prepared according to Example 3 and comparative cells prepared according to Example 3A were evaluated for their specific energy properties.

The cycling conditions used were C/2 rate, 3 V to 4.2 V (Constant Voltage [CV] step at 4.2 V until C/20 rate) at 25° C.

The results are presented in FIGS. 8 and 9.

The results demonstrated that lithium-ion cells according to the disclosure demonstrated that lithium-ion cells according to the present disclosure:
possessed 13% more specific energy (mWh/cm²) than a comparative example;
exhibited an average of 1% greater energy efficiency (%) over the cycle life than a comparative example.

### Example 7—Cycle Life/Degree of Pre-Lithiation

Cells according to the disclosure prepared according to Example 3B, Example 3C and Example 3D were evaluated for their capacity retention properties.

This analysed the number of cycles at which the capacity fell to 80% of the initial capacity as a function of the lithium Reserve/Lithium Utilization.

Lithium Reserve is the lithium content in the silicon in the discharged state of the full cell normalized to the mass of the silicon in the silicon anode. Increasing the degree of pre-lithiation increases this lithium reserve.

Lithium Utilization is the amount of lithium being used during cycling normalised to the mass of silicon in the silicon anode.

The results are reproduced below in Table 1, and depicted in FIG. 10. The lithium reserve is an indirect measure of the degree of pre-lithiation, with a higher number corresponding to a higher degree of pre-lithiation. In this example, the lithium reserve value of 686 mAh/g corresponds to 19% of the theoretical maximum.

TABLE 1

| Cathode | Li | | | Reserve/ | #Cycles @ |
|---|---|---|---|---|---|
| (mAh/ | reserve | Utilization | Remaining | Utilization | 80% capacity |
| cm2) | (mAh/g) | (mAh/g) | (mAh/g) | (—) | retention |
| 3.5 | 686 | 1819 | 495 | 38% | 176 |
| 3.5 | 700 | 1859 | 441 | 38% | 179 |
| 3.5 | 1128 | 1672 | 200 | 67% | 198 |
| 3.5 | 934 | 1791 | 275 | 52% | 153 |
| 3.5 | 1149 | 1706 | 145 | 67% | 196 |
| 3.5 | 1130 | 1741 | 129 | 65% | 181 |
| 3.5 | 1414 | 1754 | −168 | 81% | 175 |
| 3.5 | 1410 | 1768 | −178 | 80% | 251 |
| 2.5 | 958 | 1445 | 597 | 66% | 259 |
| 2.5 | 955 | 1481 | 564 | 64% | 274 |
| 3.5 | 1142 | 1697 | 161 | 67% | 231 |
| 3.5 | 1111 | 1721 | 168 | 65% | 240 |
| 3.5 | 696 | 889 | 1415 | 78% | 307 |
| 3.5 | 710 | 888 | 1402 | 80% | 318 |
| 3.5 | 932 | 850 | 1218 | 110% | 430 |
| 3.5 | 932 | 850 | 1218 | 110% | 430 |
| 3.5 | 1172 | 869 | 959 | 135% | 428 |
| 3.5 | 1176 | 887 | 937 | 133% | 451 |
| 4.5 | 1484 | 1663 | −147 | 89% | 37 |
| 4.5 | 1484 | 1663 | −147 | 89% | 36 |
| 4.5 | 1236 | 1689 | 75 | 73% | 46 |
| 4.5 | 1238 | 1689 | 73 | 73% | 44 |
| 4.5 | 987 | 1672 | 341 | 59% | 43 |
| 4.5 | 981 | 1672 | 347 | 59% | 43 |
| 4.5 | 737 | 1682 | 58 | 44% | 185 |
| 4.5 | 732 | 1682 | 586 | 44% | 201 |
| 4.5 | 1375 | 1560 | 65 | 88% | 36 |
| 4.5 | 1482 | 1311 | 207 | 113% | 40 |
| 4.5 | 1222 | 1311 | 467 | 93% | 62 |
| 4.5 | 1225 | 1311 | 464 | 93% | 65 |
| 4.5 | 984 | 1280 | 736 | 77% | 202 |
| 4.5 | 984 | 1280 | 736 | 77% | 202 |
| 4.5 | 730 | 1306 | 964 | 56% | 204 |
| 4.5 | 734 | 1315 | 951 | 56% | 209 |

As can be seen from FIG. 10, a linear relationship between (Lithium Reserve/Lithium Utilization) and cycle life was observed.

1. A method of manufacturing a lithium-ion cell (12), comprising the steps of:
(i) providing a silicon anode (6);
(ii) pre-lithiating the silicon anode (6) to form a pre-lithiated silicon anode (1) with a pre-lithiation level of from 1% to 100%;
(iii) providing a providing: a separator (2); an electrolyte; and a lithium-ion cathode (3);
(iv) forming a lithium-ion cell from the pre-lithiated silicon anode (1), the separator (2) and the lithium-ion cathode (3),
wherein the silicon anode (6) comprises:
a lithium storage material, in which the lithium storage material comprises between 70 and 100 wt. % silicon with respect to the lithium storage material; wherein the lithium storage material comprises silicon material with a columnar morphology; and
a current collector.

2. The method of claim 1, in which the lithium storage material comprises of from 90.0 to 100.0 wt. % silicon.

3. The method of claim 1, wherein the step of pre-lithiating the silicon anode (6) to form a pre-lithiated silicon anode (1) is conducted to achieve a pre-lithiation level of from 2% to 80%.

4. The method of claim 1, wherein the silicon anode (6) comprises a layer of lithium storage material.

5. The method of claim 1, wherein the lithium storage material comprises silicon material with nanoscale structures on the surface, and a nanoscale columnar morphology.

6. The method of claim 1, wherein the step of pre-lithiating the silicon anode (6) to form a pre-lithiated silicon anode (1) is selected from one of the following methods:
electrochemical pre-lithiation of the silicon anode (6) with a sacrificial lithium-ion cathode (4);
treating the silicon anode (6) with a sacrificial electrolyte salt; or
physical deposition of lithium on the silicon anode (6).

7. The method of claim 1, wherein the cathode is selected from a carbon/sulphur composite, or an air electrode, in particular carbon-based electrodes comprising graphitic carbon.

8. The method of claim 1, wherein the electrolyte comprises a lithium salt selected from LiAsF₆; Li₂SO₄; LiBF₄; LiBr; LiCF₃SO₃; LiCl; LiClO₄, LiI; LiNO₂; LiNO₃; LiSCN; lithium 2-trifluoromethyl-4,5-dicyanoimidazole (CAS: 761441-54-7); lithium (fluorosulfonyl)-(trifluoromethylsulfonyl) imide (LiFTFSI); lithium bis(fluorosulfonyl)imide (LiFSI); lithium bis(oxalato)borate (LiBOB); lithium bis(pentafluoroethanesulfonyl)imide (LiBETI); lithium bis(trifluoromethanesulfonyl)imide (LiTFSI); lithium difluoro (oxalato)borate (LiDFOB CAS: 409071-16-5); lithium trifluoromethanesulfonate (LiTf); LiPF₆; or any combination thereof.

9. The method of claim 1, wherein the electrolyte comprises a solvent selected from: (i) an ester; (ii) a sulfur-containing solvent; (iii) a phosphorus-containing solvent; (iv) an ether; (v) a nitrile; or (vi) any combination thereof.

10. The method of claim 1, wherein the silicon anode (6) is pre-lithiated to form a pre-lithiated silicon anode (1) with a pre-lithiation level of from 2% to 80%.

11. A lithium-ion cell (12) obtainable by a method comprising the steps of
(i) providing a silicon anode (6);
(ii) pre-lithiating the silicon anode (6) to form a pre-lithiated silicon anode (1) with a pre-lithiation level of from 1% to 100%;
(iii) providing a providing: a separator (2); an electrolyte; and a lithium-ion cathode (3);
(iv) forming a lithium-ion cell from the pre-lithiated silicon anode (1), the separator (2) and the lithium-ion cathode (3),
wherein the silicon anode (6) comprises:
a lithium storage material, in which the lithium storage material comprises between 70 and 100 wt. % silicon with respect to the lithium storage material; wherein the lithium storage material comprises silicon material with a columnar morphology; and
a current collector.

12. A lithium-ion cell (12) comprising:
a pre-lithiated silicon anode (3) with a pre-lithiation level of from 1% to 100%, wherein the lithium storage material comprises silicon material with a columnar morphology;
a separator (4);
an electrolyte (5); and
a lithium-ion cathode (6).

13. The lithium-ion cell (12) according to claim 12, wherein the lithium-ion cathode (6) has a lithiation level of from 70% to 100%.

14. The lithium-ion cell according to claim 12, wherein the pre-lithiated silicon anode (3) has a pre-lithiation level of from 2% to 80%.

15. The lithium-ion cell according to claim 12, wherein the lithium-ion cathode (6) is selected from a carbon/sulphur composite, or an air electrode, in particular carbon-based electrodes comprising graphitic carbon.

16. The lithium-ion cell (12) according to claim 12, wherein the lithium-ion cell is configured for storage of energy.

17. The lithium-ion cell (12) according to claim 12, wherein the lithium-ion cell is incorporated within a battery.

18. The lithium-ion cell (12) according to claim 17, wherein the batter is configured as an energy storage device.
